(19) United States
(12) Patent Application Publication
(10) Pub. No.: US 2024/0339071 A1
(43) Pub. Date: Oct. 10, 2024

(54) COLUMN DRIVERS WITH SELECTABLE CURRENT SOURCES

(71) Applicant: X Display Company Technology Limited, Dublin (IE)

(72) Inventors: Imre Knausz, Fairport, NY (US); Ronald S. Cok, Rochester, NY (US)

(21) Appl. No.: 18/132,886

(22) Filed: Apr. 10, 2023

(51) Int. Cl. G09G 3/32

(52) U.S. Cl. CPC G09G 3/32; G09G 3/3692; G09G 2300/043; G09G 2300/0456; G09G 2300/0819; G09G 2310/0278; G09G 2320/0233; G09G 2320/045; G09G 2320/064

(57) ABSTRACT

A constant-current passive-matrix array includes a two-dimensional array of pixels. Rows of pixels are each connected in common to a row wire and to a row controller operable to select one of the row wires with a row-select signal. Columns of pixels are each connected in common to a column wire and to a column controller. The column controller provides received pixel values to different column-control circuits, each connected to a column wire. Each column-control circuit comprises constant-current sources and a constant-current-source selection circuit operable to individually and separately enable each of the constant-current sources in response to the pixel value with a constant-current-source selection signal. The outputs of the constant-current sources are electrically connected in parallel to a column wire and the constant-current sources together are operable to output a constant-current column-data signal in response to the constant-current-source selection signals. The array can be a display or display cluster.

### CROSS REFERENCE TO RELATED APPLICATION

Reference is made to U.S. patent application Ser. No. 17/822,962 filed Aug. 29, 2022, entitled Hybrid Pulse-Width-Modulation Control by Knausz et al., the disclosure of which is incorporated by reference herein in its entirety.

### TECHNICAL FIELD

The present disclosure relates to pixel control circuits for light-emitting displays that use temporally variable constant-current control.

### BACKGROUND

Flat-panel displays are widely used to present images and information in graphic user interfaces controlled by computers. Such displays incorporate an array of light-controlling pixels. Each pixel emits or otherwise controls light. For example, liquid crystal displays control light emitted from a back light with a light-blocking liquid crystal at each pixel, organic light-emitting displays emit light from a stack of organic films, and inorganic light-emitting displays emit light from semiconductor crystals. In binary displays, each pixel controls light to be on at a desired brightness or off at a zero brightness. More commonly, pixels control light over a range of luminances, from zero to a maximum desired luminance. The luminance range can be referred to as a gray scale and is defined as a bit depth for a computer-controlled display, for example an eight-bit range (gray scale or bit depth) having 256 different luminance levels or a 12-bit range (gray scale or bit depth) having 4096 different luminance levels. In general, a greater luminance range is preferred to display images with more shades of light and dark in a color or color combination, such as white.

Depending on the pixel light-control technology, the luminance of a pixel can be controlled by driving a pixel over a range of voltages, over a range of currents, or at a constant power (e.g., at a given voltage and current) for a variable amount of time. Pixels that control light with variable time periods can use pulse-width modulation techniques that assign each bit of a multi-bit pixel value to a time period having a temporal length corresponding to the relative value of the bit in the multi-bit pixel. For example, in a four-bit pixel, the least-significant bit can have a temporal period equal to one minimum period and the most-significant bit can have a temporal period equal to eight minimum periods. However, the minimum period can have a value that is limited by the electronic circuits driving the pixels, thereby limiting the luminance range of pixels in a display at a given image frame rate.

There is a need, therefore, for pixel control circuits in displays using temporal modulation that provide improved gray-scale bit depth and image frame rates.

### SUMMARY

According to some embodiments of the present disclosure, among other embodiments, a hybrid pulse-width-modulation pixel comprises a light controller that emits light at different luminances within or during a temporal image frame period in response to a variable power signal and a pixel controller operable to control the light controller during the image frame period. The pixel controller can be operable to receive a pixel luminance signal comprising multiple binary bits representing a desired light-controller luminance within or during the image frame period, generate the variable power signal in response to the pixel luminance signal, and drive the light controller with different amounts of power to emit light at different luminances within or during an image frame period in response to the variable power signal for different time periods within or during the image frame period. In some embodiments, the pixel controller is operable to provide the variable power signal at a constant first power for a first time period within or during the image frame period and provide the variable power signal at a constant second power different from the constant first power for a second time period within or during the image frame period. In some embodiments, the first period and the second period do not temporally overlap. As used herein, a constant power is constant over a specified time period. The amount of power provided to the light controller can be different in different time periods but is substantially constant during each time period (ignoring switching times or slew rates). In some time periods, the amount of power provided can be zero or substantially zero with no desired light output from the light controller.

In some embodiments, the pixel luminance signal specifies a pulse-width-modulation signal comprising pulse periods (pulses) of different temporal length, each temporal length corresponding to a relative value of at least some of the bits in the pixel luminance signal, for example relative values that are powers of two in a binary number system. In some embodiments, the pulse periods can be each a first time period during which power is provided at the constant first power. In some embodiments, a first pulse period of the pulse periods can be a first time period during which power is provided at the constant first power and a second pulse period of the pulse periods can be a second time period during which power is provided at the constant second power.

The pulse-width-modulation signal can have a minimum pulse width and the second time period can be substantially no less than or substantially equal to the minimum pulse width. The first time period can be longer than the second time period. By substantially is meant within design or manufacturing limitations. In some embodiments, the pixel controller is operable to provide the variable power signal at the constant second power for a third time period. The third time period can have the same length as or a length different from the second time period. In some embodiments, the pixel controller is operable to provide the variable power signal at a constant third power different from the first or second powers for a second time period.

In some embodiments, all of the multiple bits in the pixel luminance signal are bits in a pulse-width-modulation signal (referred to as temporal bits, each of which can be controlled at one or more powers). In some embodiments, some but not all of the multiple bits of the pixel luminance signal are bits in a pulse-width-modulation signal (the temporal bits) and the bits in the multiple bits of the pixel luminance signal that are not bits in the pulse-width-modulation signal (remaining bits) are power bits. A pixel luminance signal can comprise one power bit, two power bits, or more than two power bits. In general, power provided corresponding to bits that are not power bits can be provided at the first power and power provided corresponding to a power bit can be provided at the second power. If multiple power bits are specified, each relative value of the power bits can, but does not necessarily, correspond to a different relative second power.

According to embodiments of the present disclosure, the pixel controller can be operable to provide the variable power signal at a constant first power for a first time period (e.g., a pulse period) having a temporal duration corresponding to a relative value of one of the temporal bits and can be operable to provide the variable power signal at a constant second power corresponding to a value of the power bit(s) for a second time period. The constant second power can be different from the constant first power and the second time period can be substantially equal to or no less than the time period corresponding to a value of one of the temporal bits, e.g., the least-significant bit of the temporal bits in the pulse-width-modulation signal, for example within design and manufacturing tolerances. Thus, according to embodiments of the present disclosure, the pixel controller drives the light controller at the constant first non-zero power during pulse periods of the pulse-width modulation (temporal) signal in which the pulse-width-modulation signal corresponding to the pulse period is on (e.g., a one) and at a zero power when the pulse-width-modulation signal corresponding to the pulse period is off (e.g., a zero). During the second time period, the pixel controller drives the light controller at the constant second non-zero power when the power bit(s) are non-zero and at a zero power when the power bit(s) are zero.

According to embodiments of the present disclosure, the one or more power bits are one power bit and the constant second power drives the light controller to emit light at a luminance substantially one half of the luminance at which the constant first power drives the light controller. In some embodiments, the one or more power bits are two power bits and the pixel controller is operable to provide the variable power signal with four different amounts of power that drive the light controller to emit light at four different corresponding luminances, e.g., zero, one quarter, one half, and three quarters (or one) relative to the luminance of the constant first power. In some embodiments, the one or more power bits are three power bits and the pixel controller is operable to provide the variable power signal with eight different amounts of power that drive the light controller to emit light at eight different corresponding luminances, e.g., zero, one eighth, one quarter, three eighths, one half, five eighths, three quarters, and seven eighths (or one) relative to the luminance of the constant first power. In some embodiments, the one or more power bits are four power bits and the pixel controller is operable to provide the variable power signal with sixteen different amounts of power that drive the light controller to emit light at eight different corresponding luminances, e.g., zero, one sixteenth, one eighth, three sixteenths, one quarter, five sixteenths, three eighths, seven sixteenths, one half, nine sixteenths, five eighths, eleven sixteenths, three quarters, thirteen sixteenths, seven eighths, and fifteen sixteenths (or one) relative to the luminance of the constant first power. In general, the one or more power bits can be P power bits and the pixel controller is operable to provide the variable power signal with 2^{P} different constant amounts of power that drive the light controller to emit light at 2^{P} different corresponding constant luminances during the power pulse period. The 2^{P} different corresponding constant luminances can each correspond to a binary weighted value of the power bits. In some embodiments, the one or more power bits are the least-significant bits in the multiple bits of the pixel luminance signal.

The light controller can be a liquid crystal, an organic light-emitting diode, or an inorganic light-emitting diode. In some embodiments, the light controller is an inorganic micro-light-emitting diode, e.g., having a length or width no greater than one hundred microns, no greater than fifty microns, no greater than twenty microns, no greater than fifteen microns, no greater than ten microns, no greater than five microns, or no greater than three microns.

In some embodiments, the light controller is driven to emit light more efficiently at the constant first power than at the constant second power and the second period is shorter than at least some of the first periods. By providing the power bits at a second power that is less efficient than the first power for a second period with a shorter temporal duration corresponding to the least-significant bit of the temporal bits, rather than for a first period that has a longer temporal duration, any loss of light-controller efficiency is reduced.

The variable power signal can be a current signal, a voltage signal, or a combination of a current signal and a voltage signal. An inorganic micro-light-emitting diode can be controlled to emit light most efficiently at a predetermined current density that can be the constant first power.

The pixel controller can be operable to provide the variable power signal at the constant second power for the second time period after providing the variable power signal at the constant first power for the first time period. The pixel controller can be operable to provide the variable power signal at the constant first power for the first time period after providing the variable power signal at the constant second power for the second time period. In some embodiments, the second time period has a first temporal portion and a second temporal portion, and the pixel controller is operable to provide the variable power signal at the constant second power for the second time period between providing the variable power signal at the constant first power for the first temporal portion and providing the variable power signal at the constant first power for the second temporal portion.

Some embodiments comprise a constant-current circuit operable to supply two, four, eight, sixteen, or more different constant currents at a desired voltage for example depending on a binary-weighted input value, e.g., corresponding to the power bits.

According to some embodiments of the present disclosure, a hybrid pulse-width-modulation-pixel display comprises an array of hybrid pulse-width-modulation pixels.

According to some embodiments of the present disclosure, methods of operating a hybrid pulse-width-modulation pixel with the pixel controller comprise receiving the pixel luminance signal, generating the variable power signal in response to the pixel luminance signal, and driving the light controller to emit light with the variable power signal for variable time periods by providing the variable power signal at a constant first power for a first time period, and providing the variable power signal at a constant second power for a second time period, wherein the constant second power is different from the constant first power. The second time period can be substantially equal to or no less than the time period corresponding to the value of the least significant of the temporal bits. The variable power signal can be provided at the constant second power for the second time period temporally before, after, or between providing the variable power signal at the constant first power for the first time period. The first time period can be a pulse period of a pulse-width-modulation signal having a temporal duration corresponding to a relative value of one of the temporal bits. Some methods comprise the pixel controller driving the light controller with the variable power signal using pulse-width modulation comprising first and second pulse periods having different temporal durations and driving the light controller at the constant first power for the first pulse period and driving the light controller at the constant second power for the second pulse period.

Some embodiments comprise switching a constant current supply from a first constant current to a second constant current after the first period and before the second period. Some embodiments comprise switching a constant current supply from a second constant current to a first constant current after the second period and before the first period.

According to embodiments of the present disclosure, a constant-current passive-matrix array comprises a two-dimensional array of pixels disposed in pixel rows and pixel columns. All of the pixels in each pixel row are connected in common to a row wire and all of the pixels in each pixel column are connected in common to a column wire. A row controller operable to select the row wire for one of the pixel rows with a row-select signal is connected to the row wire for each of the pixel rows. A column controller is connected to the column wire for each of the pixel columns. For each of the column wires, the column controller comprises a respective column-control circuit connected to the column wire, the column controller is operable to provide a pixel value to the respective column-control circuit connected to the column wire, the respective column-control circuit comprises constant-current sources and a constant-current-source selection circuit operable to individually and separately enable each of the constant-current sources with a constant-current-source selection signal in response to the pixel value, and outputs of the constant-current sources are electrically connected in parallel to the column wire and the constant-current sources are together operable to output a constant-current column-data signal in response to the constant-current-source selection signal. Each of the pixels can comprise an inorganic light-emitting diode selectable with a row-select signal. Each of the inorganic light-emitting diodes can emit light in response to a constant-current column-data signal. Each of the pixels can comprise multiple inorganic light-emitting diodes, each of the inorganic light-emitting diodes can be selectable with a common row-select signal on a common row wire, and each of the inorganic light-emitting diodes can emit light in response to different constant-current column-data signals provided on separate column wires. In some embodiments, the multiple inorganic light-emitting diodes in each of the pixels are operable to emit different colors of light, for example red, green, and blue, for example using separate and different light controllers such as inorganic light-emitting diodes that can be separately controlled with separate constant-current sources in response to separate variable-power signals.

In embodiments, the constant-current sources in the respective column-control circuit each provide a substantially same amount of current. In embodiments, the constant-current sources in the respective column-control circuit have a substantially same size (e.g., area). In embodiments, the constant-current sources in the respective column-control circuit are operable to provide substantially binary-weighted amounts of current. In embodiments, the constant-current sources in the respective column-control circuit have substantially binary-weighted sizes or have substantially binary-weighted areas.

In some embodiments of the present disclosure, the pixels (e.g., light controllers or inorganic light-emitting diodes) emit light in response to current with an efficiency and emit light at different efficiencies in response to different currents. A first constant-current source in the respective column-control circuit can have a first size and can be operable to provide a first current and a second constant-current source in the column-control circuit can have a second size and can be operable to provide a second current that is equal to the first current.

In some embodiments, the pixels emit light at a first luminance efficiency in response to a first current and emit light at a second luminance efficiency different from the first luminance efficiency in response to a second current different from the first current. The relative sizes, areas, power provided, or current provided by the constant-current sources can be adjusted or adapted to compensate for the differences in light-controller efficiency at different currents. For example, a first constant-current source in a respective column-control circuit (i) can be operable to provide a current or power and/or (ii) can have a size (e.g., area) corresponding to, related to, or dependent upon the first luminance efficiency and a second constant-current source in a respective column-control circuit (i) can be operable to provide a current and/or (ii) can have a size (e.g., area) corresponding to, related to, or dependent upon the second luminance efficiency. In some embodiments, a first constant-current source can be operable to provide a first current and/or can have a first size (e.g., first area) that is no more than 20% (e.g., no more than 10%, no more than 5%, or no more than 1%) larger than a second current provided by the second constant-current source during operation and/or than a second size (e.g., second area) of the second constant-current source. In some embodiments, a first constant-current source can be operable to provide a first current and/or can have a first size (e.g., first area) that is no more than 220% (e.g., no more than 210%, no more than 205%, or no more than 201%) larger than a second current provided by the second constant-current source during operation and/or than a second size (e.g., second area) of the second constant-current source.

In embodiments of the present disclosure, the constant-current column-data signal comprises a pulse-width modulation signal comprising multiple temporal pulse periods (e.g., pulses) of different temporal lengths. The constant-current column-data signal can comprise a power signal representing different amounts of power or current. The power signal can be a digital binary power signal having one, two, three, four, five, or six bits and the constant-current sources can comprise two, four, eight, sixteen, thirty-two, or sixty-four constant-current sources.

Embodiments of the present disclosure, comprise multiple constant-current passive-matrix arrays. Each of the constant-current passive-matrix arrays can be a cluster and each of the clusters can be disposed in a two-dimensional array comprising display rows and display columns. For each of the display rows, all of the clusters in the display row can be connected in common to a display row wire. For each of the display columns, all of the clusters in the display column can be connected in common to a display column wire. The display can comprise a display row controller connected to the display row wire of each of the display rows that is operable to select the display row wire for one of the display rows with a cluster row-select signal and a display column controller connected to the display column wire of each of the display columns that is operable to provide pixel values to each of the columns of clusters. Some embodiments comprise a substrate on which the clusters are disposed, and the row controller and column controller can be disposed between pixels on the substrate.

In embodiments of the present disclosure, a constant-current column driver comprises a column-control circuit can be operable to input a pixel value and output current-source enable signals and constant-current sources are each operable to output a fixed current in response to an enabling constant-current-source selection signal. The constant-current sources can have outputs that are electrically connected in parallel to provide a constant-current column-data signal. Constant-current sources with outputs electrically connected in parallel can be considered to be connected in parallel even if they are individually and separately controllable or enabled.

In embodiments of the present disclosure, a variable-power light-emitting system can comprise a light controller and a control circuit electrically connected to the light controller. The control circuit can be responsive to a pixel luminance signal to provide a first pulse-width-modulation signal for controlling a light controller with a first power and a second pulse-width-modulation signal for controlling the light controller with a second power that is different from the first power.

According to embodiments of the present disclosure, a method of controlling a pixel that comprises one or more light controllers can comprise providing a constant-current signal for each time period of a set of time periods thereby causing at least one of (e.g., all of) the one or more light controllers to control (e.g., emit or controllably reflect or absorb) light. The set of time periods can be comprised in a frame period for the pixel (or light controller) and the constant-current signal can have different currents for different ones of the time periods. The time periods (e.g., pulses or pulse periods) can be time periods in a pulse-width modulation signal or in multiple different pulse-width modulation signals. The multiple pulse-width modulation signals can be comprised in the frame period.

Some embodiments comprise changing the current of the constant-current signal between different ones of the time periods by changing which of different sets of individually and separately selectable constant-current sources electrically connected to the pixel is selected (e.g., by selecting at least one additional one of the constant-current sources not in the set, unselecting at least one of the constant-current sources in the set, or both) and providing the constant-current signal during each of the time periods using the set of constant-current sources selected for that time period.

In some embodiments, methods of controlling a pixel that comprises one or more light controllers using constant-current sources electrically connected to the pixel during a frame period comprises varying which of the constant-current sources are operated (e.g., provide current) over the frame period thereby causing the one or more light controllers to control (e.g., emit or controllably reflect or absorb) light using different constant currents at different time periods within the frame period. Varying which of the constant-current sources are operated can comprise selecting a different one or more of the constant-current sources (e.g., with a selection signal) for the different time periods (e.g., by selecting at least one additional one of the constant-current sources not in the set, unselecting at least one of the constant-current sources in the set, or both).

Some embodiments comprise selecting a first set of one or more of the constant-current sources, providing a constant-current signal using during a first time period that is comprised in the frame period thereby causing the one or more light controllers to control (e.g., emit or controllably reflect or absorb) light, selecting a second set of one or more of the constant-current sources, wherein the second set is different from (e.g., is not identical to) the first set (e.g., comprises at least one of the constant-current sources that is not comprised in the first set, does not comprise at least one of the constant-current sources that is comprised in the first set, or both); and providing a constant-current signal using during a second time period that is comprised in the frame period thereby causing the one or more light controllers to control (e.g., emit or controllably reflect or absorb) light. The second time period can be mutually exclusive from the first time period and the constant-current signal during the second time period can have a different current than the constant-current signal during the first time period. The signal can comprise a pulse-width modulation signal. One or more light controllers can comprise two or more light controllers. The one or more light controllers can be each a light-emitting diode. The pixel can be comprised in an array of pixels in a display. The pixel can be comprised in a passive-matrix pixel cluster that is a mutually exclusive subset of the array of pixels. The display can comprise an array of clusters. The display can be a passive-matrix display. The clusters can each be a passive-matrix display or comprise a passive-matrix array of light controllers. The display can provide active-matrix control to the array of cluster and each cluster can provide passive-matrix control to light controllers in the cluster.

In embodiments, the constant-current sources can be electrically connected in parallel to a common wire and the common wire can be electrically connected to the pixel. For example, outputs of the constant-current sources can be electrically connected in parallel to a common wire and the common wire can be electrically connected to the pixel.

Certain embodiments of the present disclosure provide a control circuit for pixels in a display that provide improved gray-scale resolution with relatively little or without any significant loss of light-controller efficiency. Control circuits disclosed herein are suitable for inorganic micro-light-emitting diodes and can be applied in an array of pixels in a display.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a schematic of a hybrid pixel comprising a light controller and a pixel controller with a detail of the pixel controller according to illustrative embodiments of the present disclosure;

FIG. 2 represents bits in a pixel luminance signal according to illustrative embodiments of the present disclosure;

FIG. 3A represents temporal bits and a single power bit in a pixel luminance signal according to illustrative embodiments of the present disclosure;

FIG. 3B represents temporal bits and two power bits in a pixel luminance signal according to illustrative embodiments of the present disclosure;

FIG. 4 generally represents temporal bits and power bits in a pixel luminance signal using ellipses according to illustrative embodiments of the present disclosure;

FIG. 5 is a general timing diagram for a pixel luminance signal comprising multiple image frames according to illustrative embodiments of the present disclosure;

FIG. 6A is a timing diagram for a pixel luminance signal with temporal pulse periods and a single power pulse period temporally following the temporal pulse periods and corresponding to a single image frame according to illustrative embodiments of the present disclosure;

FIG. 6B is a timing diagram for a pixel luminance signal with temporal pulse periods and two power pulse periods temporally following the temporal pulse periods and corresponding to a single image frame according to illustrative embodiments of the present disclosure;

FIG. 6C is a timing diagram for a pixel luminance signal with one power pulse period temporally between the temporal pulse periods and corresponding to a single image frame according to illustrative embodiments of the present disclosure;

FIG. 6D is a timing diagram for a pixel luminance signal with one power pulse period temporally before the temporal pulse periods and corresponding to a single image frame according to illustrative embodiments of the present disclosure;

FIG. 6E is a timing diagram corresponding to FIG. 6A illustrating pulse periods according to illustrative embodiments of the present disclosure;

FIGS. 7A-7H2 show relative luminance output over time for each value of a three-bit pixel luminance signal having two temporal bits and one power bit according to illustrative embodiments of the present disclosure;

FIG. 8A shows relative luminance output over time for a four-bit pixel luminance signal equal to ten having three temporal bits and a single power bit and FIG. 8B shows luminance output over time for a four-bit pixel luminance signal equal to eleven having three temporal bits and a single power bit according to illustrative embodiments of the present disclosure;

FIG. 9A shows luminance output over time for a five-bit pixel luminance signal equal to twenty having three temporal bits and two power bits, FIG. 9B shows luminance output over time for a five-bit pixel luminance signal equal to twenty-one having three temporal bits and two power bits, FIG. 9C shows luminance output over time for a five-bit pixel luminance signal equal to twenty-two having three temporal bits and two power bits, and FIG. 9D shows luminance output over time for a five-bit pixel luminance signal equal to twenty-three having three temporal bits and two power bits according to illustrative embodiments of the present disclosure;

FIG. 10A is a timing diagram for a pixel luminance signal comprising multiple image frames according to illustrative embodiments of the present disclosure;

FIG. 10B is a timing diagram for a pixel luminance signal for a single image frame according to illustrative embodiments of the present disclosure;

FIG. 10C is a timing diagram corresponding to FIG. 10B illustrating pulse periods according to illustrative embodiments of the present disclosure;

FIGS. 11A-11G show relative luminance output over time for each value of a three-bit pixel luminance signal having one additional power level according to illustrative embodiments of the present disclosure;

FIGS. 12A-12O show relative luminance output over time for each value of a four-bit pixel luminance signal having one additional power level according to illustrative embodiments of the present disclosure;

FIGS. 13A-13M show relative luminance output over an image frame period for each value of a four-bit pixel luminance signal having three additional power levels according to illustrative embodiments of the present disclosure;

FIG. 14A is a general timing diagram for a pixel luminance signal in an image frame comprising temporal bits and power bits, both implemented with pulse-width modulation but at different power levels, according to illustrative embodiments of the present disclosure;

FIG. 14B is a timing diagram for a pixel luminance signal in an image frame period comprising three temporal bits and two power bits, both implemented with pulse-width modulation but at different power levels, according to illustrative embodiments of the present disclosure;

FIGS. 15A-15P show relative luminance output over an image frame period for each value of a four-bit pixel luminance signal having two temporal bits and two power bits according to illustrative embodiments of the present disclosure;

FIG. 16 is a graph showing the efficiency of LEDs at various current densities according to illustrative embodiments of the present disclosure;

FIG. 17 is a flow diagram of methods according to illustrative embodiments of the present disclosure;

FIG. 18 is a schematic of a hybrid pulse-width-modulation-pixel display according to illustrative embodiments of the present disclosure;

FIG. 19 is a schematic of a hybrid pulse-width-modulation-pixel display or cluster according to illustrative embodiments of the present disclosure;

FIG. 20 is a schematic of a hybrid pulse-width-modulation-pixel display with clusters according to illustrative embodiments of the present disclosure;

FIG. 21 is a schematic of a column-control circuit with same-size constant-current sources according to illustrative embodiments of the present disclosure;

FIG. 22 is a schematic of a column-control circuit with binary-weighted-size constant-current sources according to illustrative embodiments of the present disclosure;

FIG. 23 is a schematic of a column-control circuit with two different constant-current sources according to illustrative embodiments of the present disclosure; and

FIG. 24 is a schematic of four binary-weighted constant-current sources according to illustrative embodiments of the present disclosure. Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF CERTAIN EMBODIMENTS

Certain embodiments of the present disclosure provide a pixel with greater gray-scale resolution at a given image frame rate or a faster image frame rate for a given gray-scale resolution useful in a display. Pixel circuits can have a limited response frequency, for example a minimum switching period or maximum switching frequency that defines the shortest controllable temporal pulse received or provided by the pixel circuits. This minimum temporal period limits the minimum amount of time that a light controller controlled by the pixel circuit can controllably emit light. This limitation also specifies the maximum frame rate in a display comprising an array of pixels. Furthermore, for pixels controlled by pulse-width modulation (PWM) signals, the smallest PWM period is likewise limited by the shortest controllable temporal pulse and therefore limits the number of different signal values possible in a given period of time (e.g., a PWM signal in an image frame time) and therefore the gray-scale resolution of the pixel. Thus, there is an inherent limit to the image frame rate and gray-scale resolution that can be supported by a pixel circuit.

The minimum temporal control period in a pixel circuit might be limited, for example, by the slew rate of an electronic input or output signal, control signal, or driving transistor, by the parasitic resistance, capacitance, or inductance of control signal wires or driving wires, by the pixel circuit's ability to drive a desired amount of current at a given voltage, or by the pixel circuit's ability to drive a desired voltage at a given current. For example, if a minimum temporal control period is five hundred nanoseconds and an eight-bit PWM signal is used to control a pixel, the maximum frame rate for a pixel is 256*0.0000005=0.000128 seconds or almost 8000 frames per second. If a twelve-bit signal PWM signal is used with a minimum temporal control period of fifty microseconds, the maximum frame rate for a pixel is almost five image frames per second. Contemporary displays can operate at frame rates of up to 480 frames per second (or more) with gray-scale resolutions of twelve bits (4096 levels) or more. In some displays, even greater gray-scale resolutions can be desired, for example sixteen or twenty bits.

The electronic circuits available in some displays can have relatively large and slow transistors (e.g., in thin-film transistor circuits coated on a display substrate). More complex circuits and faster-switching materials can operate at higher frequencies and provide more power at higher voltages but can be more expensive or unavailable for a given display. There is, therefore, a need for pixel circuits, in particular digital pixel control circuits, that can provide improvements in frame rate and gray-scale resolution without requiring expensive and complex control circuits.

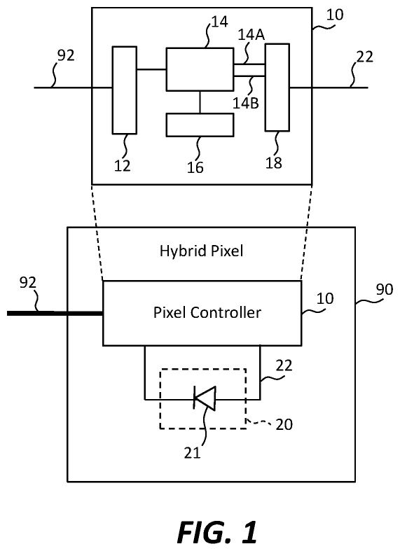

According to embodiments of the present disclosure and as illustrated in FIG. 1, a hybrid pulse-width-modulation pixel 90 comprises a pixel controller 10 and a light controller 20 that emits light in response to a variable-power signal 22 specifying different powers that drives light controller 20 to emit light. The different powers can be different electrical powers, for example electrical power levels such as different electrical currents provided at different voltages. In some embodiments, the different powers are different electrical currents provided at a common voltage.

Pixel controller 10 can be operable to receive a pixel luminance signal 92 comprising multiple bits representing a desired light-controller luminance, generate variable-power signal 22 in response to pixel luminance signal 92, and drive light controller 20 to emit light at different luminances with different amounts of power in response to variable-power signal 22 for different time periods, e.g., at a first power for a first time period and at a second power different from the first power for a second time period. The first time period can, but does not necessarily, have a temporal duration different from the temporal duration of the second time period. In embodiments of the present disclosure, variable-power signal 22 is an optical signal, a current signal, a voltage signal, or a combination of a current signal and a voltage signal (e.g., an electrical power signal). (To simplify the discussion, a luminance (or relative luminance) is often referred to as a power or relative power that is necessary to achieve the luminance, but it will be understood that the actual power is that which is necessary to achieve the desired luminance. For example, a power or luminance might be referred to as one half of a desired level, but it will be understood that the actual power is the power necessary to achieve a relative luminance of one half.)

FIG. 1 also illustrates a detail of pixel controller 10. (In the Figures, for clarity signals are not distinguished from wires or light pipes on which the signals can be transmitted.) Pixel luminance signal 92 can be received by an input circuit 12 that forwards the signal to a control circuit 14. Control circuit 14 can decode pixel luminance signal 92 and provide timing signals 14A and control power signals 14B to a drive circuit 18. Control circuit 14 can use a memory 16 to which control circuit 14 is connected. Drive circuit 18 produces variable-power signal 22 and provides it to light controller 20. Light controller 20 can be an inorganic light-emitting diode 21. Other suitable light-controlling (e.g., light-emitting) elements of light controller 20 are known in the art. For simplicity and clarity, light controller 20 is referred to herein as “emitting” light whether light controller 20 emits light itself, such as with an organic or inorganic light-emitting diode, or selectively controls light propagation that originates elsewhere (e.g., using selective reflectance or filtering), such as in a liquid crystal display.

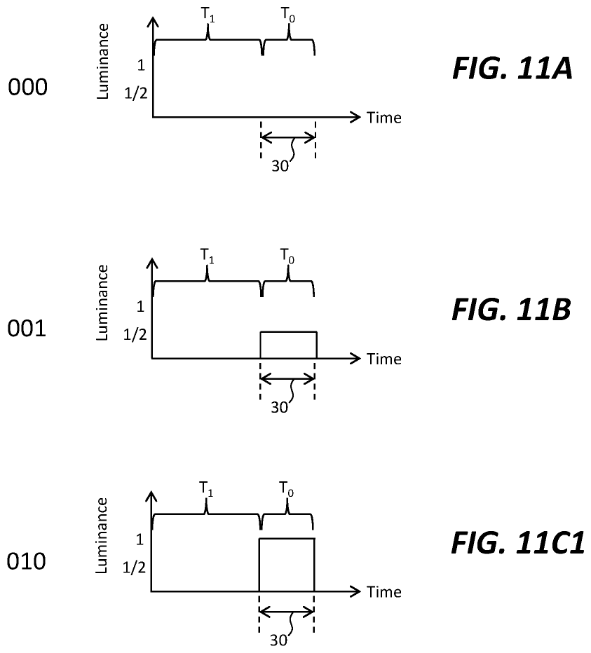

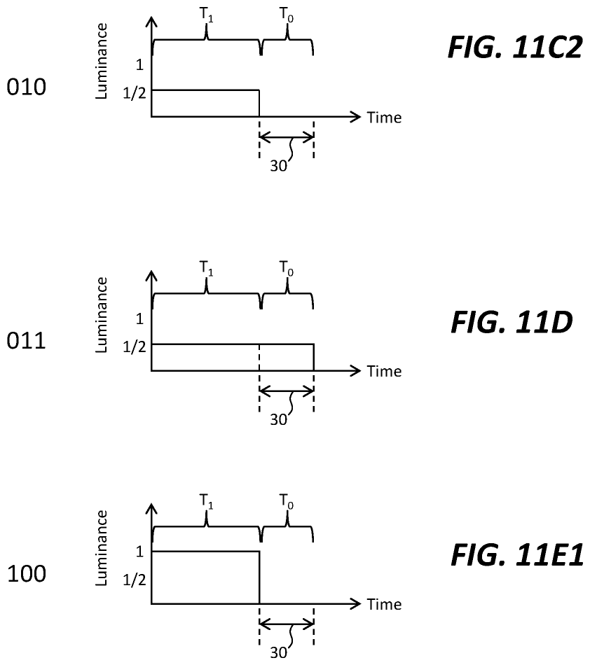

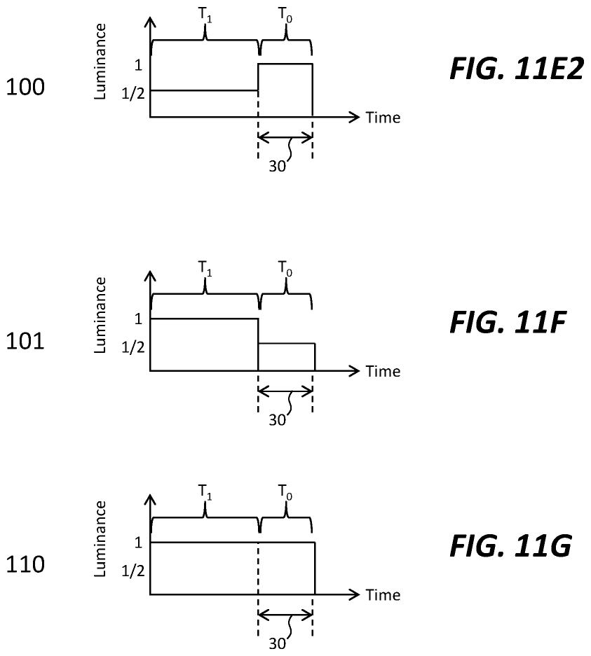

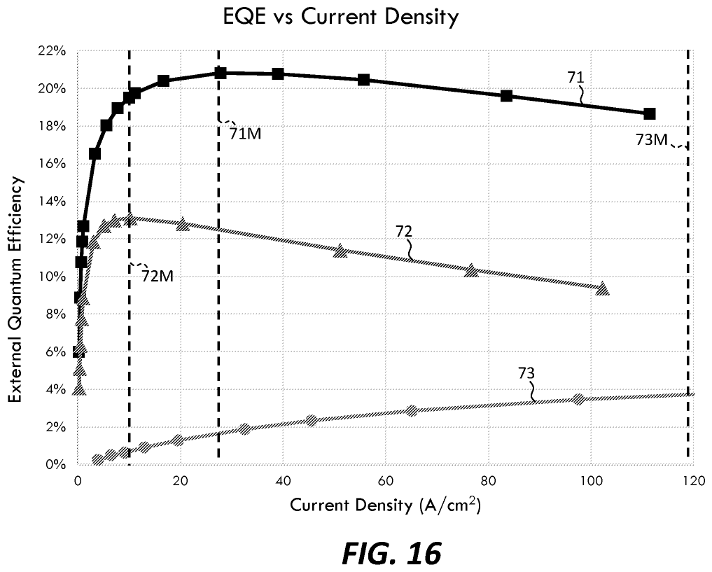

Input circuit 12, control circuit 14, memory 16, and drive circuit 18 (e.g., pixel controller 10) can all be digital or mixed-signal circuits provided in one or more integrated circuits (e.g., silicon integrated circuits) and disposed on a display substrate 88 (e.g., as shown in FIG. 16, discussed below) or on a pixel substrate disposed on a display substrate 88. Pixel controller 10 can be native to a display substrate 88, native to a pixel substrate, or provided in integrated circuits disposed on and non-native to display substrate 88 or a pixel substrate, for example by micro-transfer printing. Light controller 20 can likewise be disposed on a display substrate 88 or on a pixel substrate and can be non-native to either or both. Such integrated circuits can be provided in bare, unpackaged die and micro-transfer printed from source wafers to a desired target substrate (e.g., a display substrate 88 or pixel module substrate) and therefore can comprise broken (e.g., fractured) or separated tethers. Similarly, light controllers 20, such as inorganic light emitting diodes 21, can be transferred from LED source wafers to a desired target substrate (e.g., a display substrate 88 or pixel module substrate). Light controllers 20 can also comprise broken (e.g., fractured) or separated tethers. Bare-die integrated circuits disposed on a display substrate 88 (e.g., as shown in the hybrid pulse-width-modulation-pixel display 94 of FIG. 11) or on a pixel module substrate can be electrically connected using photolithographic or printed-circuit board methods and materials. Signals transmitted between integrated circuits or within an integrated circuit and to light controller 20 can be electrically conductive patterned thin-film metal electrical interconnects or wires 86 (e.g., metal wires 86) or light pipes, for example photolithographically defined on a display substrate 88, pixel substrate, or in integrated circuits. Power and ground signals can be provided on wires 86 to pixel controller 10 or light controller 20 (not shown in the Figures) to operate pixel controller 10 and light controller 20.

Variable-power signal 22 can specify pulses of desired current at a desired voltage (e.g., with a desired electrical power) to cause light controller 20 to emit light at a desired luminance for a desired temporal period of time. In the first time period, the power can correspond to a desired light controller 20 luminance corresponding to a constant first power. In the second time period, the power can correspond to a desired light controller 20 luminance corresponding to a constant second power. The power provided during the second time period can be less than the power provided during the first time period. The second time period can be the minimum controllable or designed pulse width or temporal period (temporal duration) for pixel controller 10, that is the minimum time that pixel controller 10 can controllably provide power to light controller 20 or a minimum time selected and designed for a pulse-width-modulation pixel circuit, for example a temporal period corresponding to a time specified by the least-significant bit in a pulse-width-modulation control method. Thus, variable-power signal 22 can specify or include a pulse-width-modulation signal having one or more temporal pulse periods all of which can be output during an image frame period. The variable-power signal 22 can be fixed at a specified power (e.g., current) during each pulse period but can provide different powers for different pulse periods and is therefore variable over an image frame period but not within a pulse period. For example, during the temporal pulse periods corresponding to the output of the T temporal bits, variable-power signal 22 can output a first fixed power (when enabled) so that it does not vary during the output of the T temporal bits but can then output a second fixed power different from the first fixed power during the pulse period corresponding to the output of the power bits P so that, over the image frame period, variable-power signal 22 outputs different amounts of power (e.g., current) and light controllers 22 has a different luminance during different pulse periods, even if the pulse periods have the same temporal duration. The pulse-width-modulation signal can include all of the multiple bits of pixel luminance signal 92 or only some, but not all, of the multiple bits. The power provided in each temporal period (pulse period) can be substantially constant (e.g., having a constant current at a constant voltage) over the temporal period, for example within design and manufacturing tolerances.

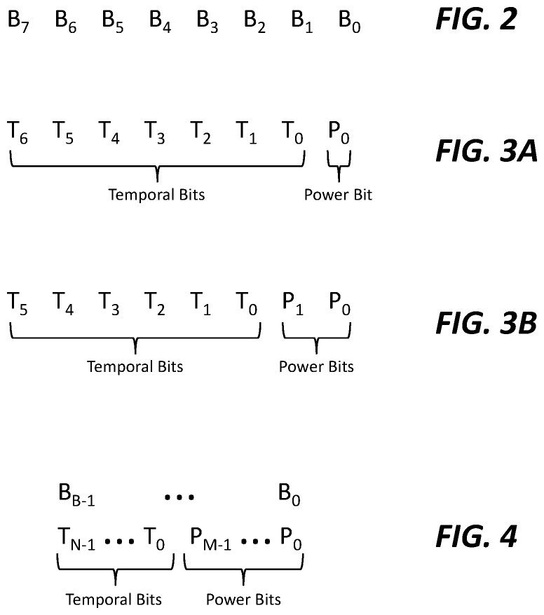

As shown in FIG. 2, pixel luminance signal 92 can comprise multiple bits B where the subscript x, as in Bₓ, represents a specific bit of multiple bits B. The multiple bits can comprise or be a digital, binary value where the subscript x represents the place or power of two of the bit in the digital binary value. The multiple bits can represent a desired luminance output for light controller 20 for a desired period of time such as an image frame time in a display.

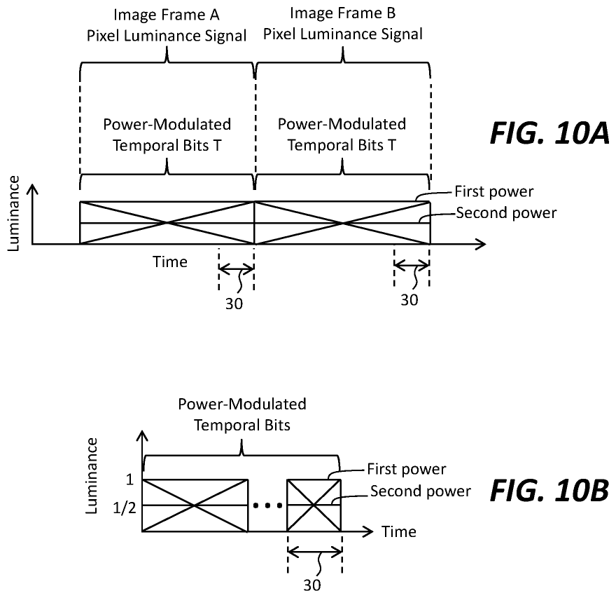

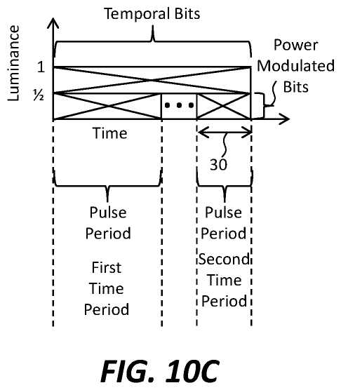

In some embodiments of the present disclosure and as illustrated in FIGS. 3-9D, the multiple bits of pixel luminance signal 92 includes (i) temporal bits T specifying a pulse-width-modulation signal having different first time periods during which light controller 20 is driven at either zero power or at the constant first power and (ii) one or more power bits representing one or more power values corresponding to a second time period during which light controller 20 is driven at zero power or at a constant second power different from the constant first power. In some embodiments of the present disclosure and as illustrated in FIGS. 10A-13M, the multiple bits of pixel luminance signal 92 specify a pulse-width-modulation signal wherein each bit corresponds to a period of time having a different temporal duration from any other of the multiple bits. During at least one of the periods of time (e.g., a first time period) light controller 20 is driven at zero power or at a constant first power and during another different one of the periods of time light controller 20 is driven at zero power or at a constant second power different from the constant first power. (As used herein, zero power means substantially zero power within design and manufacturing limitations and, in some embodiments, is not exactly zero. Similarly, constant first and second powers are substantially constant for a time period at the desired power within design and manufacturing limitations and, in some embodiments, is not exactly constant or exactly at the desired first or second power and can exclude switching time.)

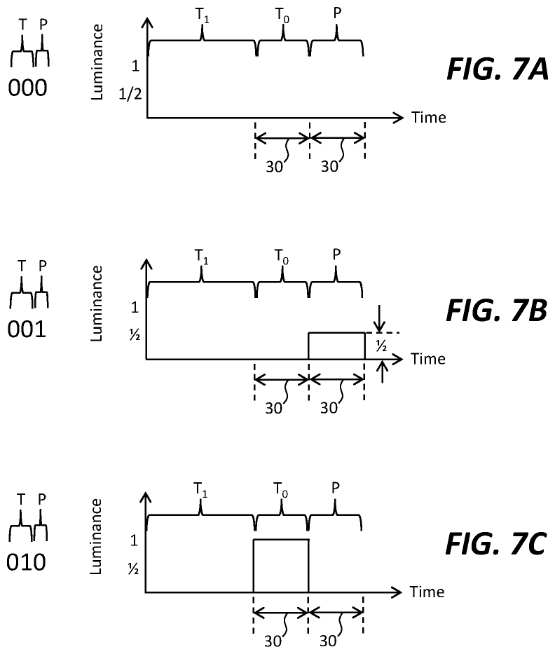

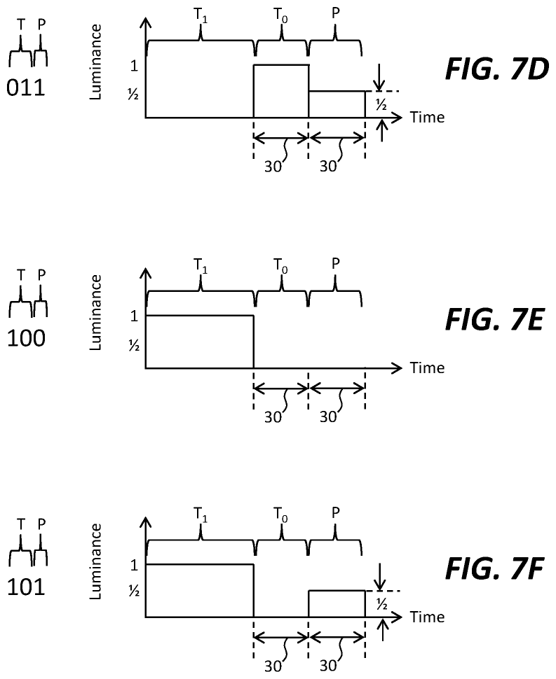

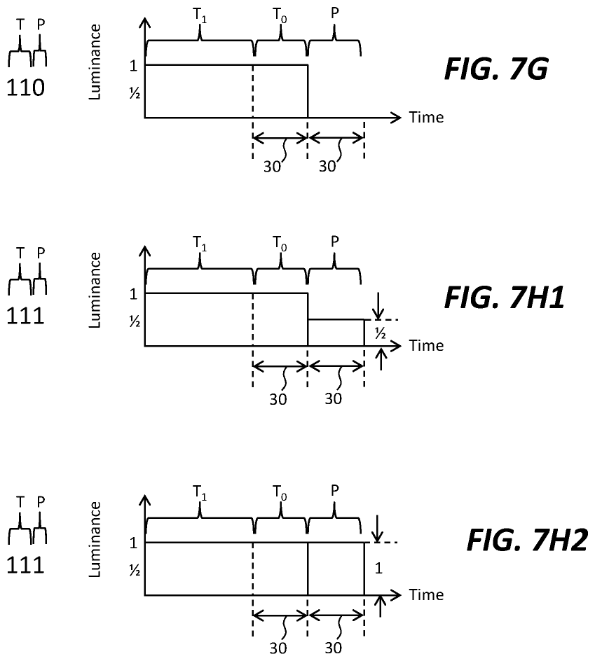

As shown in FIGS. 3-6E and with reference to the examples of FIGS. 7A-9D corresponding to some embodiments, some of multiple bits B in pixel luminance signal 92 (shown as Bₓ where x is the bit place in a binary number comprising the multiple bits) are temporal bits T (shown as T_{y} where y is the bit place in a binary number comprising the temporal bits) and a remainder of the multiple bits B are one or more power bits (shown as Pₓ where x is the bit place in a binary number comprising the power bits). Temporal bits T can represent a pulse-width-modulation signal separate from power bits P. Pixel controller 10 is operable to provide variable-power signal 22 at a constant first power for a first time period corresponding to a pulse period specified by a value of a temporal bit T (e.g., a PWM period) and provide variable-power signal 22 at a constant second power corresponding to a value of the power bits P for a second time period separate from time periods specified by temporal bits T. The constant second power can be different from the constant first power and the second time period can be substantially equal to or less than the time period corresponding to the value of temporal bits T or substantially equal to the time period corresponding to the least-significant bit of temporal bits T. The least-significant bit of temporal bits T can represent the shortest temporal period of a pulse-width-modulation signal or can be a minimum temporal control period in a pixel circuit. In general, a pulse-width modulation (PWM) signal has at least two pulse periods of different temporal length.

Variable-power signal 22 can be substantially constant, e.g., a substantially constant current or constant voltage signal, or both, over the first time period and over the second time period when variable-power signal 22 is not zero within design and manufacturing limitations. For example, variable-power signal 22 can be a binary signal (either off at a power level of zero or on at a desired constant power) during the first time period and can be either off (e.g., at zero and corresponding to a zero bit) or on (e.g., corresponding to a one bit) at a constant second power level different from the first power level for the second time period. By substantially equal to is meant within manufacturing tolerances as designed and without regard to signal switching times. The examples of FIGS. 7A-9D that follow specify the second time period as having an equal temporal duration as the time period corresponding to the least-significant bit of temporal bits T.

Hybrid pulse-width-modulation pixel 90 can be a pixel in an array of pixels in a display and can provide pulse-width-modulation control in response to temporal bits T and pulse-amplitude control in response to power bits P of bits B of pixel luminance signal 92. According to embodiments of the present disclosure, pixel luminance signal 92 comprises at least one power bit P but can have any number of power bits P less than the number of bits B in pixel luminance signal 92. Likewise, for such embodiments, pixel luminance signal 92 comprises at least one temporal bit T but can have any number of temporal bits T less than the number of bits B in pixel luminance signal 92. Thus, in embodiments of the present disclosure, every multiple-bit pixel luminance signal 92 comprises at least one (or at least two) temporal bits T and at least one power bit P. Temporal bit(s) T and power bit(s) P can be encoded in multiple-bit pixel luminance signal 92 in any desired arrangement. For simplicity, temporal bits T are encoded as a binary value with the most-significant bit (MSB) located at the left of a written representation of temporal bits T and the least-significant bit (LSB) located at the right of a written representation of temporal bits T and the bits ordered in magnitude from left to right. Similarly, power bits P are encoded as a binary value with the most-significant bit (MSB) located at the left of a written representation of power bits P and the least-significant bit (LSB) located at the right of a written representation of power bits P and the bits ordered in magnitude from left to right. Power bits P are not interlaced between temporal bits T in pixel luminance signal 92 (but could be) and are written as the least-significant bits of pixel luminance signal 92. However, this arrangement of bits as written or communicated to hybrid pulse-width-modulation pixel 90 is completely arbitrary; any desired bit arrangement can be used.

As shown in FIG. 2 and according to some embodiments, a pixel luminance signal 92 can comprise multiple bits B (e.g., bits B₀ to B₇, for an eight-bit pixel luminance signal 92). Pixel luminance signal 92 can comprise any number of bits B greater than or equal to two. FIGS. 3A and 3B show pixel luminance signal 92 of the embodiments divided into temporal bits T and power bits P. Power bits P can be, but are not necessarily, the least-significant bits of multiple bits B. FIG. 3A illustrates seven temporal bits T₀ to T₆ and a single power bit P₀ in eight-bit pixel luminance signal 92 of FIG. 2. FIG. 3B illustrates six temporal bits T₀ to T₅ and two power bits P₀ to P₁ in eight-bit pixel luminance signal 92 of FIG. 2. More generally and as shown in FIG. 4, pixel luminance signal 92 can have B bits (e.g., B_{B-1} to B₀) divided into N temporal bits T_{N-1} to T₀ and M power bits P_{M-1} to P₀, where N+M=B. The illustrations of FIGS. 2, 3A, and 3B with eight bits are exemplary; the number of bits B can be any integer larger than one and N and M can be any non-zero value where N+M=B. In general, and for example, the number of bits B specifying a desired pixel luminance at given frame rate is limited by electronic or optical transmission rates on a display backplane, the number of bits N is limited by electronic or optical transmission rates on a display backplane or circuitry clock rates in hybrid pulse-width-modulation pixel 90, and the number of bits M is limited by the size and complexity of pixel control circuit 14 and drive circuits 18 in hybrid pulse-width-modulation pixel 90. The actual number of bits B, N, or M will be a consequence of, for example, design and hardware choice and limitations in a display comprising an array of hybrid pulse-width-modulation pixels 90.

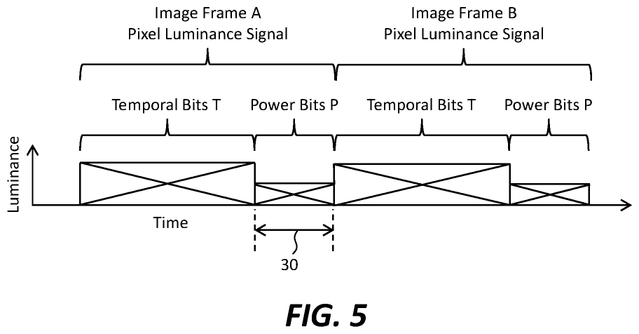

As shown in FIG. 5 and according to embodiments of the present disclosure, images comprise pixels that are each displayed by a hybrid pulse-width-modulation pixel 90 in an array of hybrid pulse-width-modulation pixels 90, for example in a display. Images (image frames) and pixel values are sequentially provided in time so that each hybrid pulse-width-modulation pixel 90 receives a pixel for each image frame, displays the pixel, and then receives a subsequent pixel of a subsequent image frame for display. Each image frame is displayed for an image frame period that comprises multiple pulse periods including pulse periods for the temporal bits and at least one pulse period for the power bits. A single pulse period for the power bits can have a temporal duration equal to the shortest pulse period of the temporal bits T, e.g., the pulse period of the least-significant temporal bit. The pulse periods for each temporal bit T can have binary-weighted durations. A single frame period (including all of the temporal pulse periods and the power period(s)) should have a temporal duration short enough to be perceived by the human visual system as a single illumination (e.g., should not exhibit flicker).

FIG. 5 illustrates a first image frame A temporally followed by second image frame B. Each image frame comprises pixels specifying a desired luminance for each hybrid pulse-width-modulation pixel 90. Pixel luminance signal 92 for each hybrid pulse-width-modulation pixel 90 in each image frame comprises B bits divided into temporal bits T and power bits P. In some embodiments, the number of temporal bits T and power bits P can be the same for each pixel in an image frame or can be different for different pixels within an image frame. In some embodiments, the number of temporal bits T and power bits P can be different between image frames. The temporal length (period) corresponding to power bits P can be a designed minimum pulse width 30 and can be separate from the number of power bits P. FIG. 5 illustrates temporal bits T at the constant first power and power bits P at the constant second power; the number of power bits requires 2^{P} constant second powers different from the constant first power.

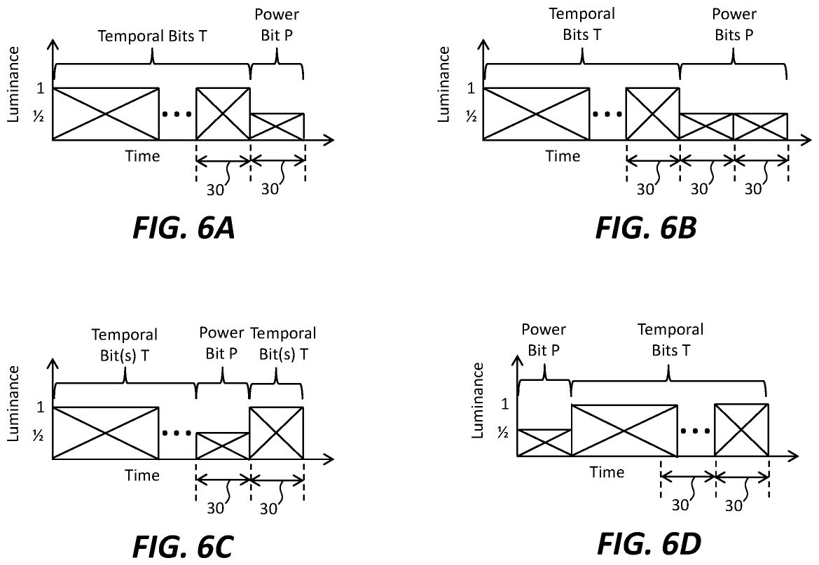

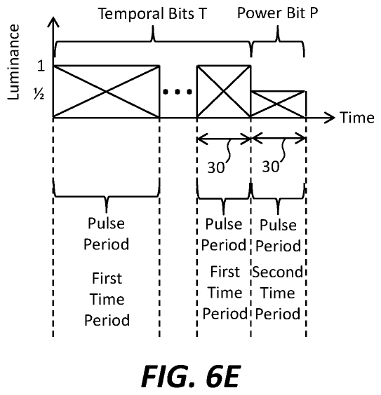

For example and as illustrated in FIG. 6A, the temporal length (minimum pulse width 30 time period) for M power bits P can be one minimum pulse width 30 time period for any or all of one, two, or three (or more) power bits P in contrast to the temporal length (periods) for temporal bits T equal to 2^{N}−1 minimum pulse width 30 time periods (where N is the number of temporal bits T and temporal bits T represent a pulse-width-modulation signal). The number of minimum pulse width 30 time periods can correspond to a binary-weighted value of temporal bits T. The total time period corresponding to the image frame can therefore be 2^{N} equal to (2^{N}−1) minimum pulse width 30 time periods for temporal bits T plus one more minimum pulse width 30 time period for any number of power bits P. In FIG. 6A, each pulse period is indicated with a crossed rectangle. Temporal bits T are output with a desired luminance corresponding to the constant first power, indicated as a relative luminance value of 1 with a corresponding more-efficient current density for the LEDs, for a time equal to 2^{N-1} minimum pulse width 30 time periods. (The ellipses represent additional pulse periods not specified in FIG. 6A.) Power bits P are output with a desired luminance that is one half of the temporal luminance at a current density that is relatively less efficient for a single minimum pulse width 30 time period. The example of FIG. 3A having seven temporal bits will thus require 128 (2⁷) minimum pulse width 30 time periods and the example of FIG. 3B having six temporal bits will thus require 64 (2⁶) minimum pulse width 30 time periods.

FIG. 6B illustrates embodiments in which power corresponding to power bits P are output in more than one minimum pulse width 30. In such embodiments, multiple power bits P can be output with fewer than 2^{P} power levels in addition to the constant first power but require one or more additional pulse periods. FIG. 6A illustrates power bit P encoded after temporal bits T and can represent the second time period temporally disposed after the first time period(s). FIG. 6C illustrates power bit P encoded within temporal bits T and can represent the second time period temporally disposed within or between pulse periods of the first time periods. FIG. 6D illustrates power bit P encoded before temporal bits T and can represent the second time period temporally disposed before the first time period(s). By disposing second time period after, between, or before pulse periods of the first time periods, flicker can be controlled, for example reduced. FIG. 6E, corresponding to FIG. 6A, graphically illustrates first and second time periods. First time periods can correspond to any one of the pulse periods of a pulse-width-modulation signal corresponding to temporal bits T at the constant first power (if not zero) and second time period temporally following first time period(s) corresponding to power bit(s) P at the constant second power (if not zero).

FIGS. 7A-7H illustrate a specific example of a three-bit pixel luminance signal 92 comprising two temporal bits T and one power bit P requiring 2¹ equal to two constant second powers (including zero). A three-bit pixel luminance signal 92 can specify eight different luminance levels, zero through seven. The constant first power can have a relative value of one and constant second power can have a relative value of ½, but the relative values are arbitrary and can be, for example, a relative constant first power of two and a relative constant second power of one equivalent to scaling (multiplying) by two. The actual power (and corresponding luminance) associated with the values is controlled by control circuit 14 and drive circuit 18 in response to the pixel luminance signal 92 bits. The example Figures simply represent the relative luminance integrated over time specified by pixel luminance signal 92 for an image frame to provide a luminance level associated with pixel luminance signal 92. Thus, in this example, temporal bits T correspond to first time periods with constant first power of zero or one and power bit P corresponds to second time period with constant second power of zero or ½. Each of FIGS. 7A to 7H illustrate the luminance output over time corresponding to each of the eight (2³) possible values of the three-bit pixel luminance signal 92 ranging from zero to seven.

As shown in the timing and luminance diagram of FIG. 7A for a pixel luminance signal 92 of zero, the luminance output for light controller 20 is zero. As shown in FIG. 7B for a pixel luminance signal 92 of one, the luminance output for light controller 20 is at a constant first power of zero for the first time periods corresponding to temporal bits T and at a constant second power of ½ for the second time period corresponding to power bit P. As shown in FIG. 7C for a pixel luminance signal 92 of two, the luminance output for light controller 20 is at a constant first power of one for a first time period corresponding to temporal bit T₀ and at a constant second power of zero for the second time period corresponding to power bit P. As shown in FIG. 7D for a pixel luminance signal 92 of three, the luminance output for light controller 20 is at a constant first power of one for a first time period corresponding to temporal bit T₀ and at a constant second power of ½ for the second time period corresponding to power bit P. As shown in FIG. 7E for a pixel luminance signal 92 of four, the luminance output for light controller 20 is at a constant first power of one for a first time period corresponding to temporal bit T₁ (having a temporal period twice that of T₀), at a power of zero for a time period corresponding to temporal bit T₀, and at a constant second power of zero for the second time period corresponding to power bit P. As shown in FIG. 7F for a pixel luminance signal 92 of five, the luminance output for light controller 20 is at a constant first power of one for a first time period corresponding to temporal bit T₁ (having a temporal period twice that of T₀), at a power of zero for a time period corresponding to temporal bit T₀, and at a constant second power of ½ for the second time period corresponding to power bit P. As shown in FIG. 7G for a pixel luminance signal 92 of six, the luminance output for light controller 20 is at a constant first power of one for a first time period corresponding to temporal bit T₁ (having a temporal period twice that of), at a constant first power of one for a time period corresponding to temporal bit T₀, and at a constant second power of zero for the second time period corresponding to power bit P. As shown in FIG. 7H1 for a pixel luminance signal 92 of seven, the luminance output for light controller 20 is at a constant first power of one for a first time period corresponding to temporal bit T₁ (having a temporal period twice that of T₀), at a constant first power of one for a first time period corresponding to temporal bit T₀, and at a constant second power of ½ for the second time period corresponding to power bit P. Thus, the output in this example ranges from zero to 3½ that (scaled by two) corresponds to relative luminance output of zero to seven, as specified by pixel luminance value 92. However, the absolute luminance is slightly smaller than a conventional pulse-width modulation method. FIG. 7H2 shows the P value of pixel luminance signal 92 of 111₂ mapped to a relative power level of one instead of ½, as in FIG. 7H1.This method provides slightly greater luminance (equivalent to that of a conventional PWM method) but has a different change in luminance with respect to changes in pixel luminance signal 92 values from a value of 110₂ to 111₂ than between the other pixel luminance signal 92 values.

As illustrated in FIGS. 7A-7H2, power bit P enables an additional half-luminance output for any value of temporal bits T, thus providing an extra bit of gray scale resolution, for example providing luminance values of (in base 10): 0, ½, 1, 1½, 2, 2½, 3, 3½, 4, 4½, 5, 5½, 6, 6½, 7, and 7½, or 16 values total, equivalent to a four-bit gray-scale resolution. Equivalently, the values can be scaled by two to provide the conventional representation of four-bit values 0₁₀ to 15₁₀ in base 10 or 0000₂ to 1111₂ in binary base two values. The luminance seen by an observer is the integral of the luminance signal over time (e.g., the total number of photons emitted over the image frame period) so long as the image frame period is short enough to avoid perceptible flicker to an observer.

Constant second power can drive light controller 20 less efficiently than constant first power. In the three-bit example of FIGS. 7A-7H1, hybrid pulse-width-modulation pixel 90 is operated with a less-efficient current for only one minimum pulse width 30 time period corresponding to the P bit and pulse for only the odd values of pixel luminance signal 92 and for only one quarter of each frame period. Thus, the loss in efficiency using the constant second power is quite small and, as the number of bits in pixel luminance signal 92, the loss in efficiency decreases.

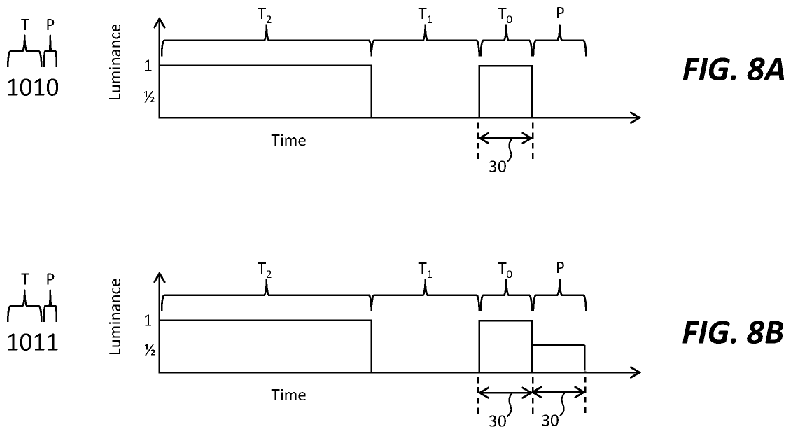

FIGS. 8A-8B illustrate embodiments with four-bit pixel luminance signals 92 having three temporal bits T and one power bit P. As shown in FIG. 8A for a value of ten (10₁₀ and 1010₂) a first time period T₂ of temporal bits T having a relative duration of four least-significant bits corresponds to a variable-power signal 22 providing a luminance of one, a first time period T₁ of temporal bits T having a relative duration of two least-significant bits corresponds to a variable-power signal 22 providing a luminance of zero, a first time period T₀ of temporal bits T having a relative duration of one least-significant bit corresponds to a variable-power signal 22 providing a luminance of one, and a second time period P corresponds to a variable-power signal 22 providing a luminance of zero, for an integrated value over the frame period of five (when scaled by a factor of two corresponding to pixel luminance signal 92 of ten). As shown in FIG. 8B for a value of eleven, a first time period T₂ of temporal bits T having a relative duration of four least-significant bits corresponds to a variable-power signal 22 providing a luminance of one, a first time period T₁ of temporal bits T having a relative duration of two least-significant bits corresponds to a variable-power signal 22 providing a luminance of zero, a first time period T₀ of temporal bits T having a relative duration of one least-significant bit corresponds to a variable-power signal 22 providing a luminance of one, and a second time period P corresponds to a variable-power signal 22 providing a luminance of ½, for an integrated value over the frame period of five and one half (when scaled by a factor of two corresponding to pixel luminance signal 92 of eleven).

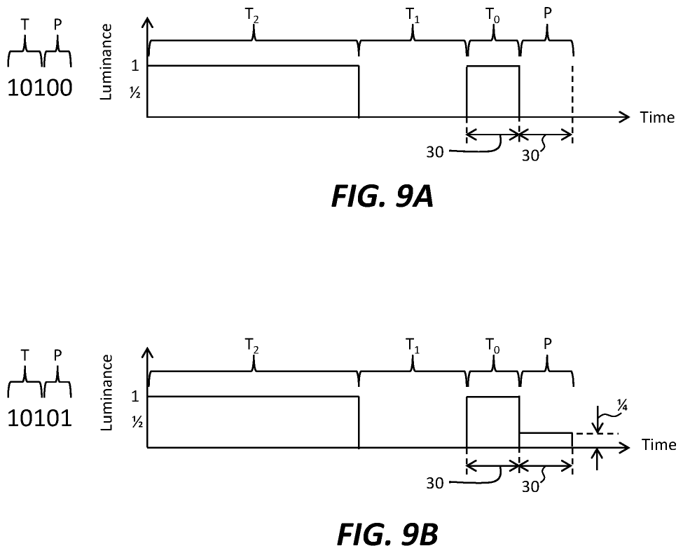

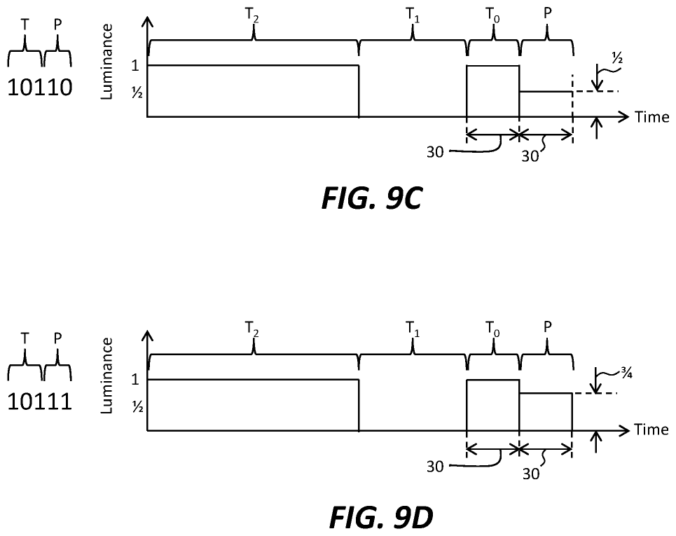

FIGS. 9A-9D illustrate embodiments with five-bit pixel luminance signals 92 having three temporal bits T and two power bits P. To provide a luminance corresponding to two power bits, 2^{P} equal to 2² or four constant second powers different from the constant first power of one can be provided: zero, ¼, ½, and ¾. In this example, the value of the three temporal bits T is arbitrarily set to 5₁₀ (101₂, any number from zero to seven could be used) and the two P bits P are set to zero, one, two, or three, corresponding to the pixel luminance values 20₁₀ (10100₂), 21₁₀ (10101₂), 22₁₀ (10110₂), and 23₁₀ (10111₂) in FIGS. 9A-9D, respectively. In the luminance and timing diagram of FIG. 9A, power bits P are set to zero and light output for the most-significant bit value of one for the temporal values T specifies constant first power at a relative luminance of one for four minimum pulse width 30 periods, the next bit at a bit value of zero for two minimum pulse width 30 periods has no power applied, and the least-significant bit outputs light for a bit value of one at a relative luminance of one for one minimum pulse width 30 period. No current is applied or light output for power bit P equal to zero. In FIG. 9B-9D, light corresponding to temporal bits T is output as for FIG. 9A, since the value of temporal bits T is the same. However, in FIG. 9B, power bits P are set to one (01₂), so that power is applied and light output for a single minimum pulse width 30 time period, but at a luminance one quarter of that of temporal bits T equal to one. In FIG. 9C, the power bits P are set to two (10₂), so that power is applied and light output for a single minimum pulse width 30 time period, but at a luminance one half of that of temporal bits T equal to one. In FIG. 9D, power bits P are set to three (11₂), so that power is applied and light output for a single minimum pulse width 30 time period, but at a luminance three quarters of that of temporal bits T equal to one.

In the embodiments of FIGS. 9A-9D, power bits P enable four luminance levels (including zero) for every value of temporal bits T, thus providing an extra two bits of gray-scale resolution in addition to the gray-scale resolution provided by temporal bits T, for example providing luminance values of (in base 10): 0, ¼, ½, ¾, 1, 1¼, 1½, 1¾, 2, 2¼, 2½, 2¾, 3, 3¼, 3½, 3¾, 4, 4¼, 4½, 4¾, 5, 5¼, 5½, 5¾, 6, 6¼, 6½, 6¾, 7, 7¼, 7½, 7¾, or 32 values total, equivalent to a five-bit gray-scale resolution. Equivalently, the values can be multiplied by four to provide the conventional representation of four-bit values from 0₁₀ to 31₁₀ in base 10 or 00000₂ to 11111₂ in binary base 2 values. Thus, the examples of FIGS. 9A-9D provide a five-bit gray scale in nearly the same image frame time as a three-bit gray scale using conventional pulse-width modulation.

In general, the number of power levels equals the number of possible values of power bits P, equal to 2^{P} (including zero and corresponding to 2^{P} different luminance levels). The number of luminance levels and power levels can correspond to a binary-weighted value of power bits P. FIGS. 7A-7H2 and 8A-8B illustrate pixel luminance signals 92 with one power bit P and two levels (0 and ½) and FIGS. 9A-9D illustrate pixel luminance signals 92 with two power bits P and four levels (0, ¼, ½, and ¾). In some embodiments of the present disclosure, pixel luminance signals 92 can comprise three power bits P and hybrid pulse-width-modulation pixel 90 is operable to provide variable-power signal 22 with eight different amounts of power (e.g., using electrical current or voltage) that drive light controller 20 to emit light at eight different corresponding luminances.

In some embodiments, a power equal to one is at least somewhat more efficient than powers equal to one quarter, one half, or three quarters. However, the less efficient output corresponding to power bits P only occurs for one minimum pulse width 30 and is therefore a relatively small portion of the total output so that power bits P do not substantially deleteriously affect the efficiency of light controller 20. There would also be a corresponding slightly greater image frame period but, again, the relatively longer frame period is relatively small, for example 1 part in 2^{B}. Thus, for an eight-bit pixel luminance signal 92 with 256 luminance levels, the increase in frame period is only about 0.4%. For a twelve-bit pixel luminance signal 92 with 4096 luminance levels, the increase in frame period is only about 0.024%. As illustrated for example in FIG. 7H1, the maximum brightness is also reduced since power bits P for the largest pixel luminance signal 92 do not correspond to a relative power of one but, as shown in FIG. 7H2, can be mapped to the maximum pixel luminance value 92 with a reduction in the uniformity of pixel luminance changes for that value (e.g., the slope of a function relating luminance to pixel luminance signal 92 value changes).

Embodiments of the present disclosure provide additional bit depths for pixel luminance signals 92. A conventional embodiment of a three-bit pulse-width-modulation signal requires seven least-significant bit periods 30 for each image frame. In contrast, with one power bit, as shown in FIGS. 7A-7H2, each image frame requires four least-significant bit periods 30. Similarly, a conventional embodiment of a four-bit pulse-width-modulation signal requires fifteen least-significant bit periods 30 for each image frame. In contrast, with one power bit, as shown in FIGS. 8A-8B, each image frame requires eight least-significant bit periods 30. A conventional embodiment of a five-bit pulse-width-modulation signal requires thirty-one least-significant bit periods 30 for each image frame. In contrast, with two power bits, as shown in FIGS. 9A-9D, each image frame requires eight least-significant bit periods 30. In general, a conventional pulse-width modulation scheme requires B pulse periods having a total duration equal to 2^{B}−1 least-significant bit pulse periods where B is the number of bits in pixel luminance signal 92. In contrast, embodiments of the present disclosure require 2^{T} least-significant bit periods where B=T+P and P is the number of power bits requiring 2^{P} powers rather than the two powers (off and on or zero and one) required by a conventional pulse-width modulation method. Thus, embodiments of the present disclosure provide reduced frame periods for an equivalent bit depth. Alternatively, for a constant frame time (ignoring the additional pulse period for the additional power least-significant bit), embodiments of the present disclosure provide a bit depth with P additional bits.

The embodiment examples of FIGS. 3A-9D add an additional pulse period for power bit P to a pulse-width-modulation signal for temporal bits T, slightly increasing the frame period. In some embodiments, instead of adding an additional pulse period modulated with different powers, each pulse-width modulation pulse period can be modulated with different powers so that each pulse period can vary in time and in power. As shown in FIG. 10A, different pulse periods (e.g., first and second time periods) associated with temporal bits T can be driven at different powers, e.g., constant first and second powers. FIG. 10B illustrates a single image frame of temporal bits T specifying a variable-power signal 22 with constant first and second powers. The crossed-through rectangles corresponding to pulse periods in FIGS. 10A-10C are shown with a horizontal line at the top to indicate a constant first power and in the center of the rectangles to indicate a constant second power as shown more explicitly in FIG. 10C. Depending on the value of pixel luminance signal 92, either the constant first power, the constant second power, or a zero power is used for each pulse period. FIGS. 10A-10C illustrate a power of ½ in addition to one and zero, but in some embodiments more powers can be used for each or any of the pulse periods, for example, two, three, four, seven, or fifteen different relative powers in addition to a relative one or zero power that causes light controller 20 to emit light at a corresponding relative luminance.

FIGS. 11A-11G illustrate an example of a three-bit pixel luminance signal 92. In a conventional pulse-width modulation method, the three bits can correspond to three pulse periods having relative lengths of four, two, and one, all driven at a relative zero or one power. In contrast and according to embodiments of the present disclosure, each of the three pulse periods can be driven at three or more powers, reducing the number of pulse periods necessary to emit light of the corresponding luminance or increasing the bit depth. The examples of FIGS. 11A-11G use three relative powers, zero, one half, and one and provide a three-bit gray scale in the same frame period that a two-bit conventional pulse-width modulation method requires.

As shown in the timing and luminance diagram of FIG. 11A for a pixel luminance signal 92 of zero, the luminance output for light controller 20 is zero for all pulse periods. As shown in FIG. 11B for a pixel luminance signal 92 of one, the luminance output for light controller 20 is at a constant first power of zero for the first time period (e.g., pulse) corresponding to temporal bit T₁ and at a constant second power of ½ for the second time period corresponding to temporal bit T₀. As shown in FIG. 11C1 for a pixel luminance signal 92 of two, the luminance output for light controller 20 is at a constant first power of zero for the first time period (e.g., pulse) corresponding to temporal bit T₁ and at a constant second power of one for the second time period corresponding to temporal bit T₀. Equivalently, and as shown in FIG. 11C2 for a pixel luminance signal 92 of two, the luminance output for light controller 20 is at a constant first power of ½ for the first time period (e.g., pulse) corresponding to temporal bit T₁ and at a constant second power of zero for the second time period corresponding to temporal bit T₀. The example of FIG. 11C1 is more power efficient since a relative power of one is used whereas in FIG. 11C2 a relative power of one half is used. However, the example of FIG. 11C2 can have reduced flicker since light is emitted for a longer duration of time with fewer light-output interruptions. As shown in FIG. 11D for a pixel luminance signal 92 of three, the luminance output for light controller 20 is at a constant first power of ½ for the first time period (e.g., pulse) corresponding to temporal bit T₁ and at a constant second power of ½ for the second time period corresponding to temporal bit T₀. As shown in FIG. 11E1 for a pixel luminance signal 92 of four, the luminance output for light controller 20 is at a constant first power of one for the first time period (e.g., pulse) corresponding to temporal bit T₁ and at a constant second power of zero for the second time period corresponding to temporal bit T₀. As shown in the alternative of FIG. 11E2 for a pixel luminance signal 92 of four, the luminance output for light controller 20 is at a constant first power of ½ for the first time period (e.g., pulse) corresponding to temporal bit T₁ and at a constant second power of one for the second time period corresponding to temporal bit T₀. As shown in FIG. 11F for a pixel luminance signal 92 of five, the luminance output for light controller 20 is at a constant first power of one for the first time period (e.g., pulse) corresponding to temporal bit T₁ and at a constant second power of ½ for the second time period corresponding to temporal bit T₀. As shown in FIG. 11G for a pixel luminance signal 92 of six, the luminance output for light controller 20 is at a constant first power of zero for the first time period (e.g., pulse) corresponding to temporal bit T₁ and at a constant second power of one for the second time period corresponding to temporal bit T₀. There is no mechanism for providing a different luminance for a pixel luminance value 92 of seven, since the number of possibly different luminance outputs is six. Thus, some methods (e.g., illustrated in FIGS. 11A-11G) can provide an expanded but more limited gray scale than other methods (e.g., illustrated in FIGS. 3-9D) in the same image frame time as a conventional pulse-width modulation method. The number of gray scale levels can be 2^{B}−2^{P} non-zero values (e.g., 2^{B}−2^{P}+1 gray levels including zero) where B is the number of bits and P is the number of additional different powers. The example of FIGS. 11A-11G have B=3 and P=1 equaling 2³−2¹=8−2=6 non-zero values.

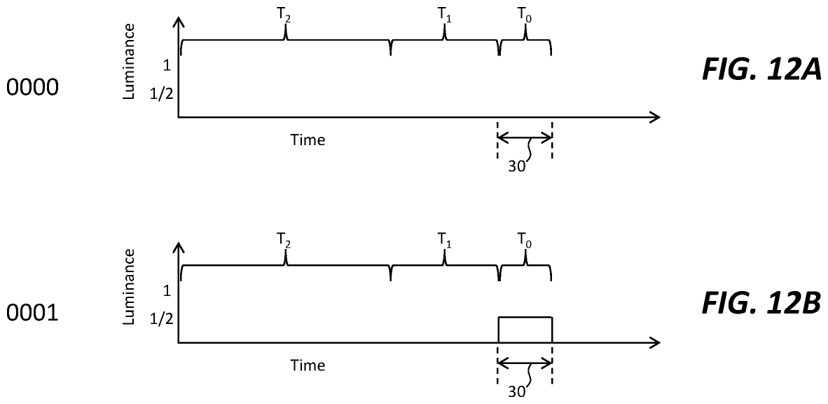

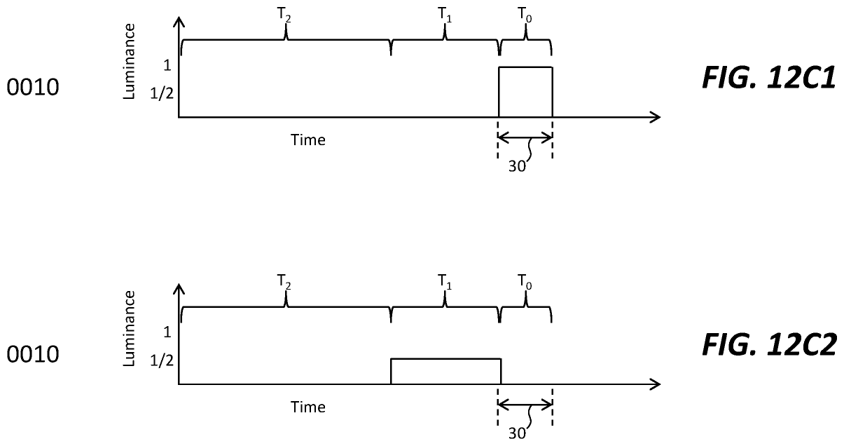

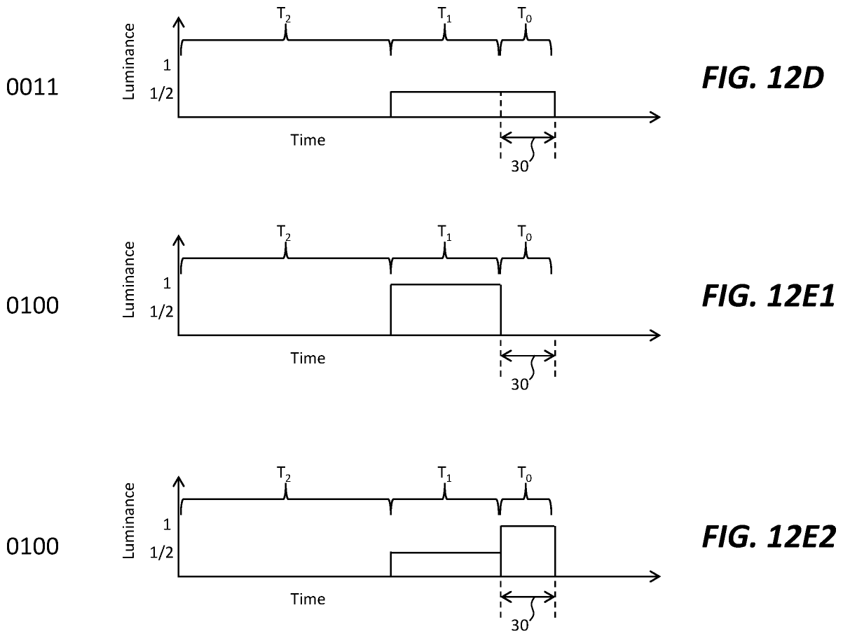

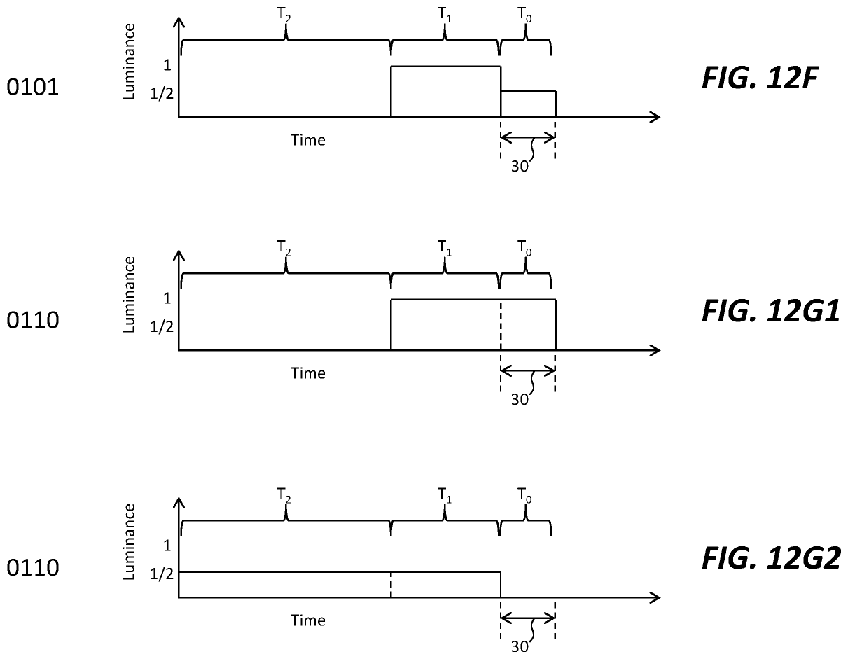

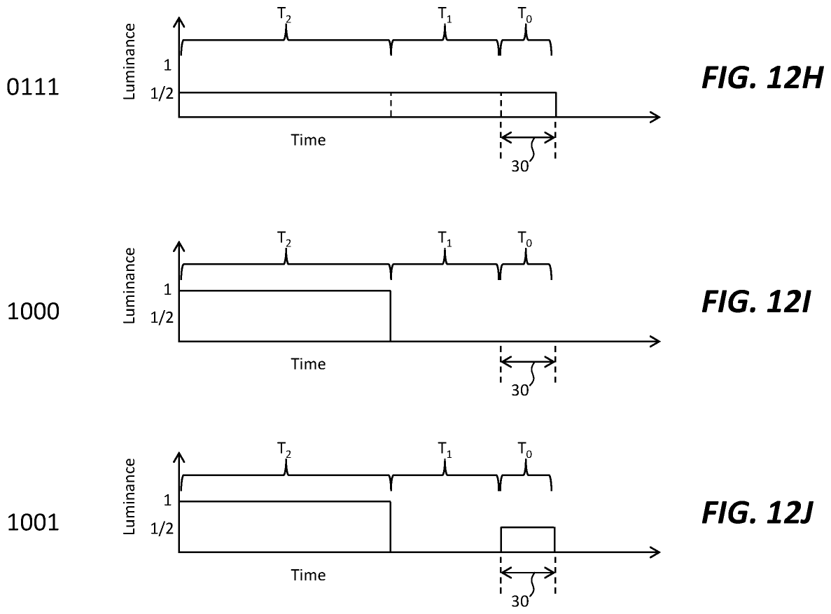

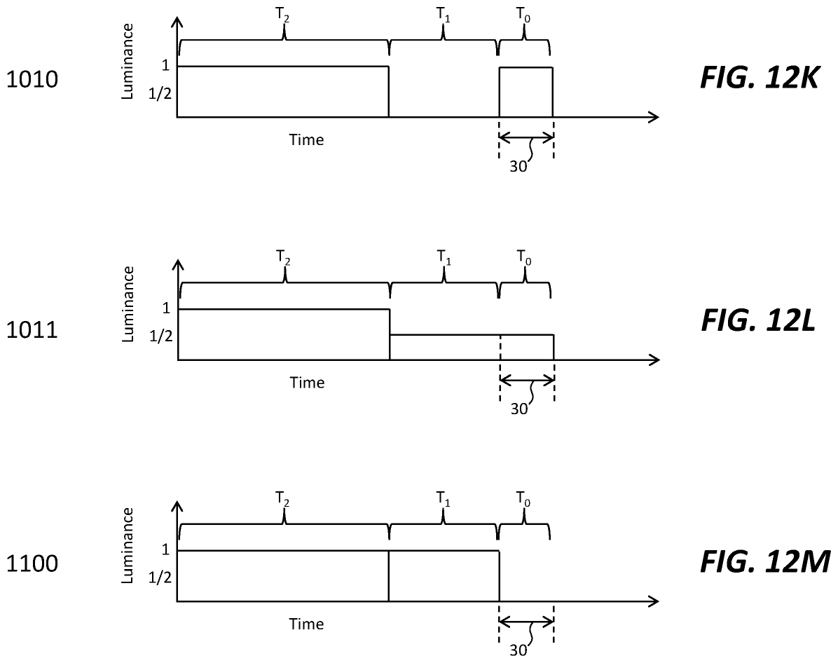

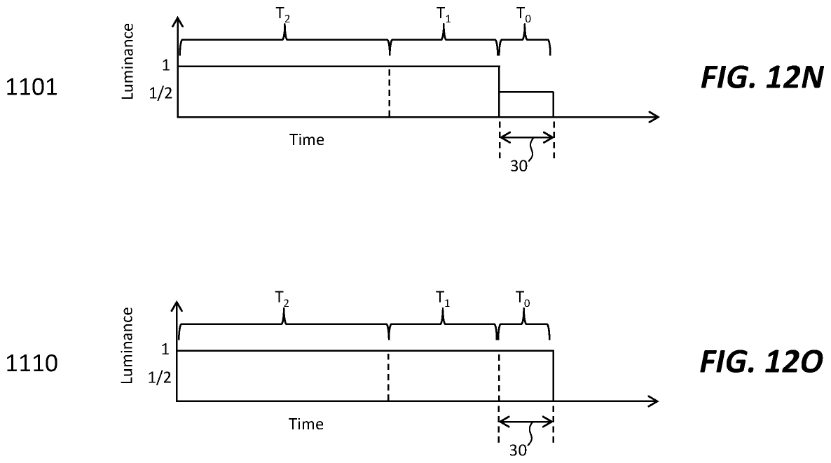

FIGS. 12A-12O illustrate an example of methods having four bits and a frame period equal to three bits for a conventional pulse-width modulation method, so that B=3 and P=1. As shown in the timing and luminance diagram of FIG. 12A for a pixel luminance signal 92 of zero, the luminance output for light controller 20 is zero for all pulse periods. As shown in FIG. 12B for a pixel luminance signal 92 of one (0001₂), the luminance output for light controller 20 is at a constant first power of zero for a first time period corresponding to temporal bit T₂, the luminance output for light controller 20 is at a constant first power of zero for a first time period corresponding to temporal bit T₁, and the luminance output for light controller 20 is at a constant second power of ½ for a second time period corresponding to temporal bit T₀. As shown in FIG. 12C1 for a pixel luminance signal 92 of two (0010₂), the luminance output for light controller 20 is at a constant first power of zero for a first time period corresponding to temporal bit T₂, the luminance output for light controller 20 is at a constant first power of zero for a first time period corresponding to temporal bit T₁, and the luminance output for light controller 20 is at a constant second power of one for a second time period corresponding to temporal bit T₀. In the alternative embodiment of FIG. 12C2, for a pixel luminance signal 92 of two (0010₂), the luminance output for light controller 20 is at a constant first power of zero for a first time period corresponding to temporal bit T₂, the luminance output for light controller 20 is at a constant first power of ½ for a second time period corresponding to temporal bit T₁, and the luminance output for light controller 20 is at a constant first power of zero for a second time period corresponding to temporal bit T₀. As discussed above with respect to FIGS. 11C1 and 11C2, the examples of FIG. 11C1 can be more efficient and the examples of FIG. 11C2 can have reduced flicker. As shown in FIG. 12D for a pixel luminance signal 92 of three (0011₂), the luminance output for light controller 20 is at a constant first power of zero for a first time period corresponding to temporal bit T₂, the luminance output for light controller 20 is at a constant second power of ½ for a second time period corresponding to temporal bit T₁, and the luminance output for light controller 20 is at a constant second power of ½ for a second time period corresponding to temporal bit T₀. As shown in FIG. 12E1 for a pixel luminance signal 92 of four (0100₂), the luminance output for light controller 20 is at a constant first power of zero for a first time period corresponding to temporal bit T₂, the luminance output for light controller 20 is at a constant second power of one for a second time period corresponding to temporal bit T₁, and the luminance output for light controller 20 is at a constant first power of zero for a first time period corresponding to temporal bit T₀. In an alternative embodiment as shown in FIG. 12E2 for a pixel luminance signal 92 of four (0100₂), the luminance output for light controller 20 is at a constant first power of zero for a first time period corresponding to temporal bit T₂, the luminance output for light controller 20 is at a constant second power of ½ for a second time period corresponding to temporal bit T₁, and the luminance output for light controller 20 is at a constant third power of one for a third time period corresponding to temporal bit T₀. As shown in FIG. 12F for a pixel luminance signal 92 of five (0101₂), the luminance output for light controller 20 is at a constant first power of zero for a first time period corresponding to temporal bit T₂, the luminance output for light controller 20 is at a constant second power of one for a second time period corresponding to temporal bit T₁, and the luminance output for light controller 20 is at a constant third power of ½ for a third time period corresponding to temporal bit T₀. As shown in FIG. 12G1 for a pixel luminance signal 92 of six (0110₂), the luminance output for light controller 20 is at a constant first power of zero for a first time period corresponding to temporal bit T₂, the luminance output for light controller 20 is at a constant second power of one for a second time period corresponding to temporal bit T₁, and the luminance output for light controller 20 is at a constant second power of one for a second time period corresponding to temporal bit T₀. In an alternative embodiment as shown in FIG. 12G2 for a pixel luminance signal 92 of six (0110₂), the luminance output for light controller 20 is at a constant first power of ½ for a first time period corresponding to temporal bit T₂, the luminance output for light controller 20 is at a constant first power of ½ for a first time period corresponding to temporal bit T₁, and the luminance output for light controller 20 is at a constant second power of zero for a second time period corresponding to temporal bit T₀. As shown in FIG. 12H for a pixel luminance signal 92 of seven (0111₂), the luminance output for light controller 20 is at a constant first power of ½ for a first time period corresponding to temporal bit T₂, the luminance output for light controller 20 is at a constant first power of ½ for a first time period corresponding to temporal bit T₁, and the luminance output for light controller 20 is at a constant first power of ½ for a first time period corresponding to temporal bit T₀.

As shown in FIG. 12I for a pixel luminance signal 92 of eight (1000₂), the luminance output for light controller 20 is at a constant first power of one for a first time period corresponding to temporal bit T₂, the luminance output for light controller 20 is at a constant second power of zero for a second time period corresponding to temporal bit T₁, and the luminance output for light controller 20 is at a constant second power of zero for a second time period corresponding to temporal bit T₀. The illustrations of FIGS. 12K-12O are the same as FIGS. 12B-12G1 except that the luminance output for light controller 20 is at a constant first power of one for a first time period corresponding to temporal bit T₂. As noted with respect to FIG. 11G, there is no gray scale equivalent for a value of fifteen (1111₂).

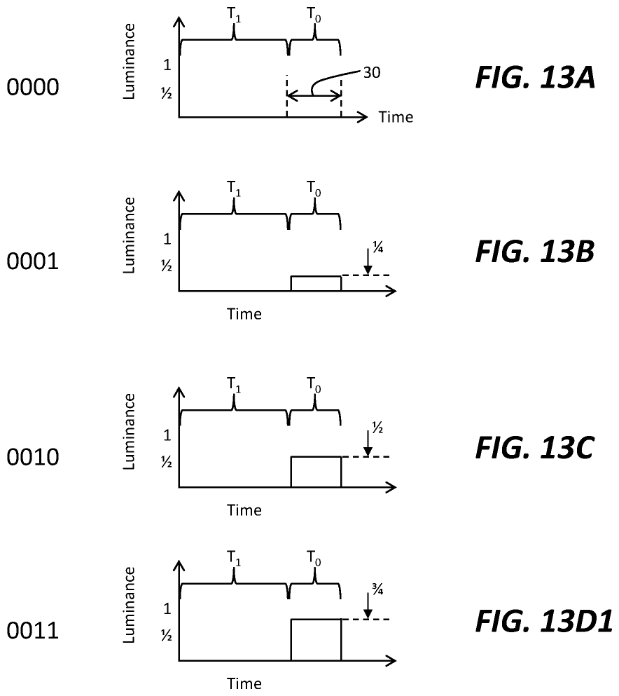

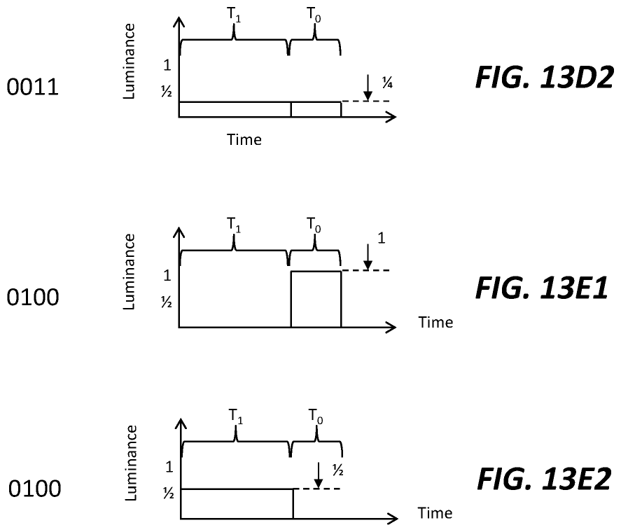

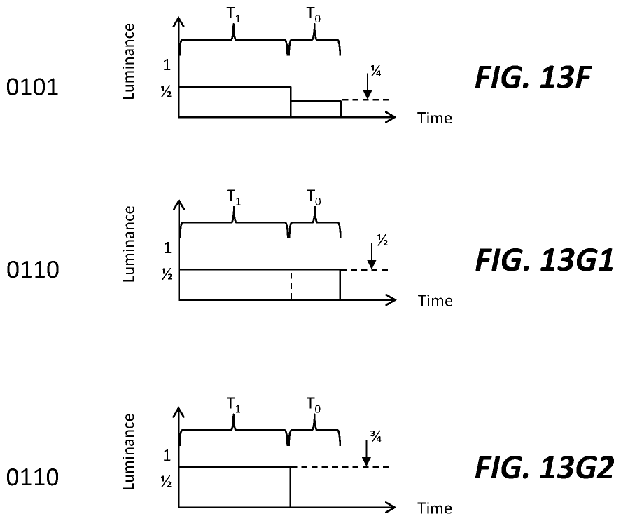

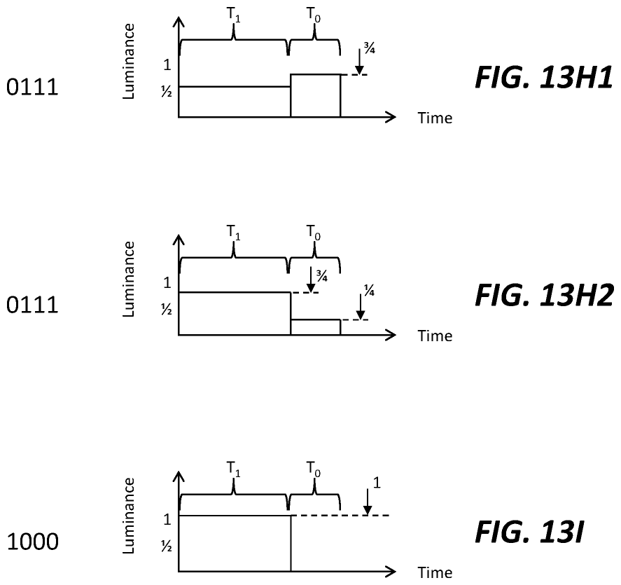

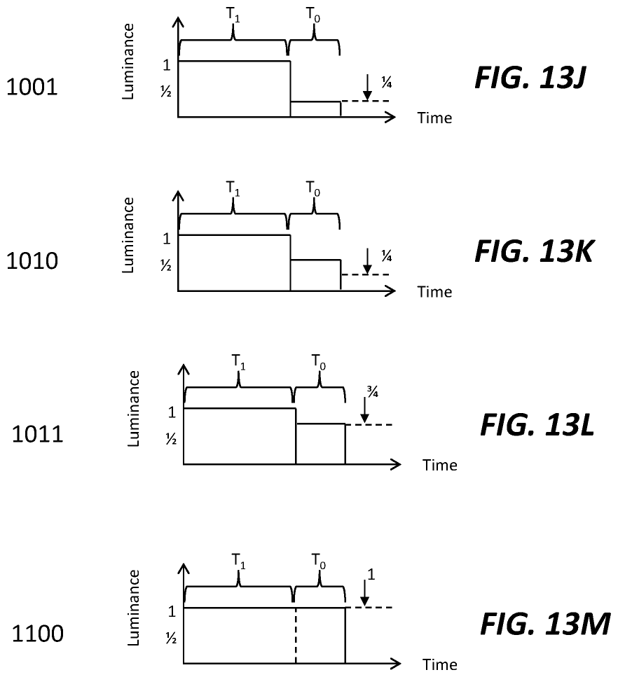

FIGS. 13A-13M illustrate embodiments in which a four-bit value is provided as a pulse-width-modulation signal with frames equal to a conventional two-bit pulse-width-modulation signal by providing five different powers, including zero and one, (e.g., the power necessary to drive light controller 22 to produce a desired different relative luminance). The powers (power levels) can be chosen to provide relative luminances of zero, ¼, ½, ¾, and one. As shown in the timing and luminance diagram of FIG. 13A for a pixel luminance signal 92 of zero, the luminance output for light controller 20 is zero for all pulse periods. As shown in FIG. 13B for a pixel luminance signal 92 of one (0001₂), the luminance output for light controller 20 is at a constant first power of zero for a first time period corresponding to temporal bit T₁, and the luminance output for light controller 20 is at a constant second power of 1/4 for a second time period corresponding to temporal bit T₀. As shown in FIG. 13C for a pixel luminance signal 92 of two (0010₂), the luminance output for light controller 20 is at a constant first power of zero for a first time period corresponding to temporal bit T₁, and the luminance output for light controller 20 is at a constant second power of ½ for a second time period corresponding to temporal bit T₀. As shown in FIG. 13D1 for a pixel luminance signal 92 of three (0011₂), the luminance output for light controller 20 is at a constant first power of zero for a first time period corresponding to temporal bit T₁, and the luminance output for light controller 20 is at a constant second power of ¾ for a second time period corresponding to temporal bit T₀. In an alternative embodiment as shown in FIG. 13D2 for a pixel luminance signal 92 of three (0011₂), the luminance output for light controller 20 is at a constant first power of ¼ for a first time period corresponding to temporal bit T₁, and the luminance output for light controller 20 is at a constant first power of ¼ for a first time period corresponding to temporal bit T₀. As shown in FIG. 13E1 for a pixel luminance signal 92 of four (0100₂), the luminance output for light controller 20 is at a constant first power of zero for a first time period corresponding to temporal bit T₁, and the luminance output for light controller 20 is at a constant second power of one for a second time period corresponding to temporal bit T₀. As shown in alternative embodiments shown in FIG. 13E2 for a pixel luminance signal 92 of four (0100₂), the luminance output for light controller 20 is at a constant first power of ½ for a first time period corresponding to temporal bit T₁, and the luminance output for light controller 20 is at a constant second power of zero for a second time period corresponding to temporal bit T₀. As shown in FIG. 13F for a pixel luminance signal 92 of five (0101₂), the luminance output for light controller 20 is at a constant first power of ½ for a first time period corresponding to temporal bit T₁, and the luminance output for light controller 20 is at a constant second power of ¼ for a second time period corresponding to temporal bit T₀. As shown in FIG. 13G1 for a pixel luminance signal 92 of six (0110₂), the luminance output for light controller 20 is at a constant first power of ½ for a first time period corresponding to temporal bit T₁, and the luminance output for light controller 20 is at a constant first power of ½ for a first time period corresponding to temporal bit T₀. In an alternative illustrated in FIG. 13G2 for a pixel luminance signal 92 of six (0110₂), the luminance output for light controller 20 is at a constant first power of ¾ for a first time period corresponding to temporal bit T₁, and the luminance output for light controller 20 is at a constant second power of zero for a second time period corresponding to temporal bit T₀. As shown in FIG. 13H1 for a pixel luminance signal 92 of seven (0111₂), the luminance output for light controller 20 is at a constant first power of ½ for a first time period corresponding to temporal bit T₁, and the luminance output for light controller 20 is at a constant second power of ¾ for a second time period corresponding to temporal bit T₀. In the alternative illustration of FIG. 13H2 for a pixel luminance signal 92 of seven (0111₂), the luminance output for light controller 20 is at a constant first power of ¾ for a first time period corresponding to temporal bit T₁, and the luminance output for light controller 20 is at a constant second power of ¼ for a second time period corresponding to temporal bit T₀. As shown in FIG. 13I for a pixel luminance signal 92 of eight (1000₂), the luminance output for light controller 20 is at a constant first power of one for a first time period corresponding to temporal bit T₁, and the luminance output for light controller 20 is at a constant second power of zero for a second time period corresponding to temporal bit T₀. FIGS. 13J, 13K, 13L, and 13M correspond to FIGS. 13B, 13C, 13D1, and 13E1, respectively except that the luminance output for light controller 20 is at a constant first power of one for a first time period corresponding to temporal bit T₁. In some embodiments there is no gray scale equivalent for a value of thirteen (1101₂), fourteen (1110₂), and fifteen (1111₂) as embodiments can be limited to a number of non-zero gray levels equal to 2^{B}−2^{P} where B is the number of bits and P is the number of additional different powers. The example of FIGS. 13A-13M have B=4 and P=2 equaling 2⁴−2²=16−4=12 non-zero values.

Embodiments of the present disclosure comprise a variable-power signal 22 that is a pulse-width modulation signal providing power at two or more different powers (e.g., currents driving a light controller 20 at two or more corresponding different luminances) for two or more different pulses (pulse periods or temporal periods in a pulse-width modulation signal). During a first pulse, light controller 20 is driven at a first power. During a second pulse different from the first pulse, light controller 20 is driven at a second power (current) different from the first power (current). As shown in FIGS. 5-9D, power (currents) associated with power bits P are emitted during a single pulse, for example having a pulse duration equal to a pulse duration corresponding to the least significant bit of temporal bits T. The power output during pulse periods corresponding to temporal bits T is the same for all of the temporal bits T pulse periods but is different from the power output during the pulse period corresponding to power bits P. (The power output can be an instantaneous power, for example an electrical current.) In all cases, the power or current output within or during a single pulse period is constant; the power of variable-power signal 22 varies between pulse periods, not within pulse periods.

In some embodiments of the present disclosure, such as are illustrated in FIGS. 10A-13M, any or all of the temporal pulses of the pulse-width modulation signal are output at different powers (at different currents). For example, power can be output at a first power during a first PWM pulse period for a first temporal bit and power can be output at a second power different from the first power during a second PWM pulse period different from the first PWM pulse period for a second temporal bit.

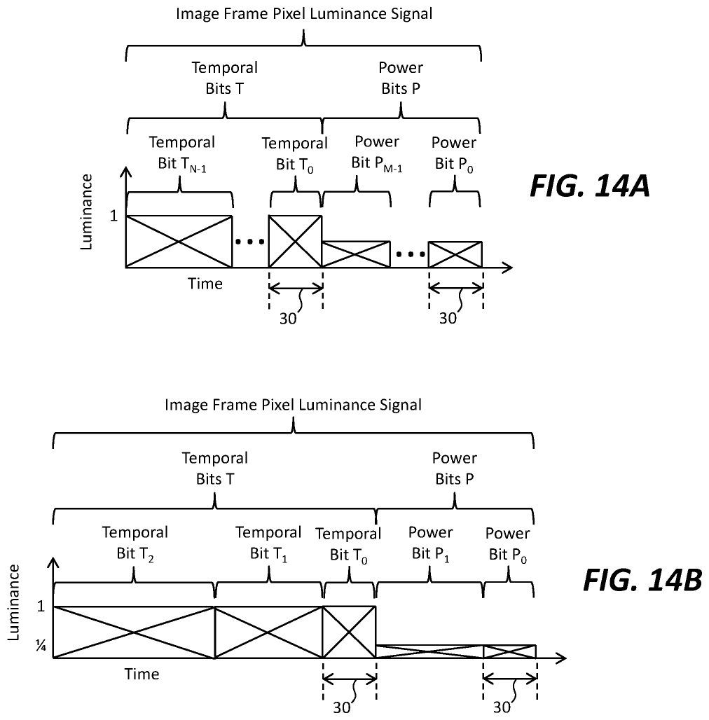

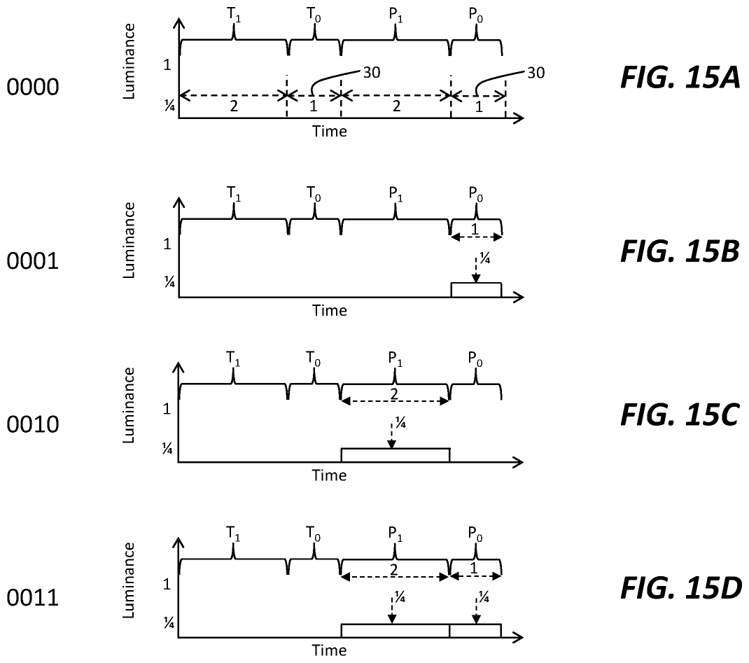

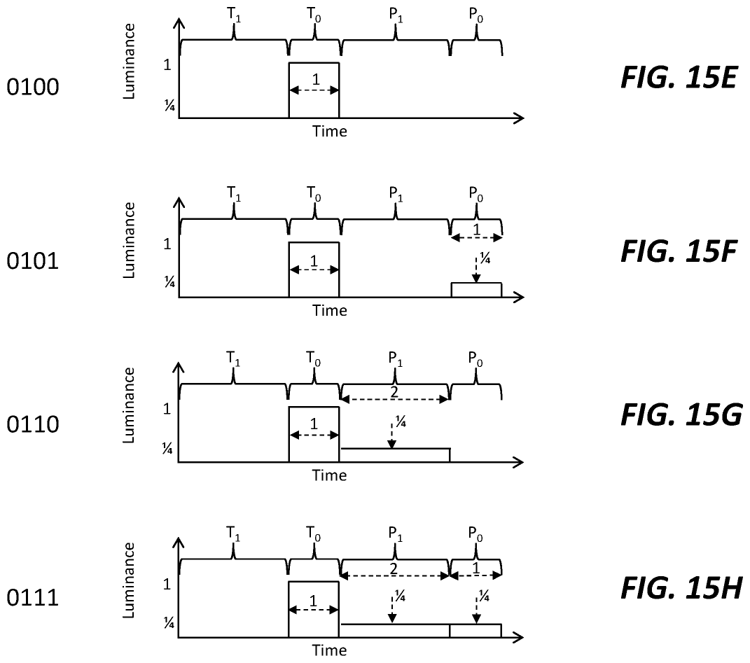

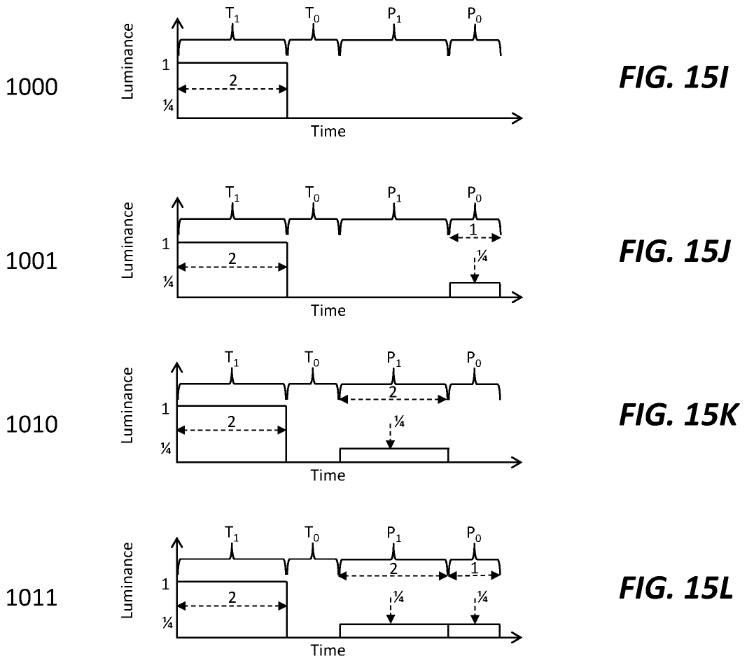

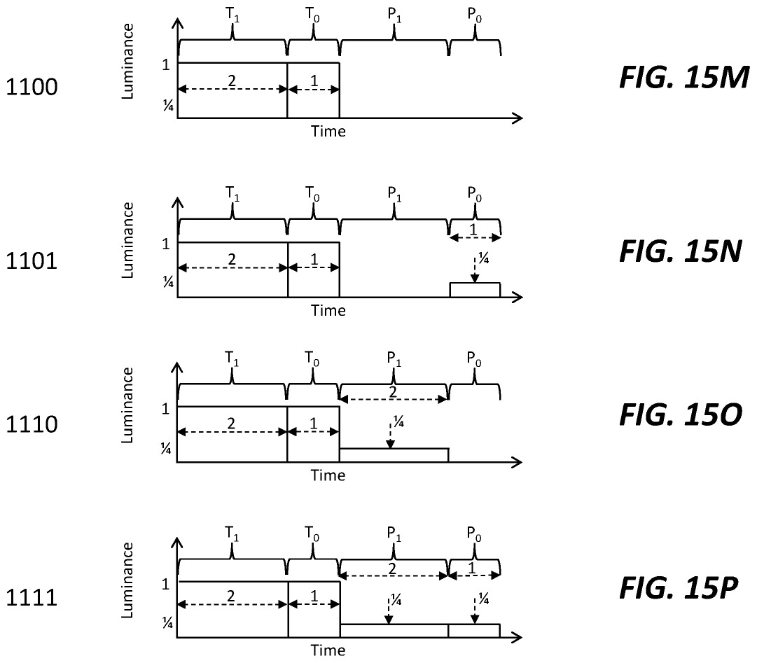

In some embodiments of the present disclosure and as illustrated in FIGS. 14A-15P, variable-power signal 22 comprises temporal bits T and power bits P, for example as shown in FIGS. 2-4, that are each separately output as pulse-width modulation signals at different power (current) levels. Thus, temporal bits T are output as a pulse-width modulation signal at a first power level (when a temporal bit T is enabled or on) and power bits P are output as a pulse-width modulation signal at a second power level (when a power bit P is enabled or on) different from the first power level. Thus, variable-power signal 22 essentially comprises two PWM signals output at two different power levels. The different pulses (and different powers) of the two PWM signals can be temporally intermixed to reduce flicker or for circuit-design reasons. For clarity in the illustrations of FIGS. 14A-15P, temporal bits T are shown first, and the power bits P are shown after the temporal bits T reading from left to right and in the direction of time, but this arrangement is arbitrary and embodiments of the present disclosure are not so limited.

As shown in FIG. 14A, in general a pixel luminance signal 92 for an image frame comprises temporal bits T and power bits P. A first luminance of light controller 20 corresponding to N temporal bits T is output as a first pulse-width modulation (PWM) signal with a first power (e.g., arbitrarily illustrated as one) and a second luminance of light controller 20 corresponding to power bits P is output as a second pulse-width modulation signal different from the first PWM signal with a second power (e.g., illustrated as less than one) different from the first power. A pulse duration corresponding to the least-significant bit of the first and second (temporal and power) PWM signals can be the same (as shown) or different. If the number of power bits P is one, this configuration is identical to those of FIGS. 3A, 6A, 7A-7H1 and 8A-8B (e.g., there is only one pulse period and two power or current levels, one for pulse periods corresponding to the temporal bits and one for the pulse period corresponding to the power bit). However, according to some embodiments of the present disclosure, the number of power bits P is two or more and the number of pulse periods corresponding to the power bits is also two or more.

FIG. 14B illustrates a non-limiting and specific example illustrating a multi-bit variable-power signal 22 (also the pixel luminance signal 92) having three temporal bits T output at an arbitrary power of one for PWM pulse period durations of four, two, and one and two power bits P output at a power of one quarter (½^{P}) for PWM pulse period durations of two and one. FIGS. 15A-15P illustrate the variable-power signal 22 (also the pixel luminance signal 92) for this specific example for the least-significant four bits of the five-bit variable-power signal 22.

FIG. 15A illustrates the signals for a variable-power signal 22 of zero. In this case, no power is output for any of the pulse periods. FIG. 15B illustrates the signals for a variable-power signal 22 of one (e.g., temporal bits T are zero and power bits P equal one or 01₂). In this case, power is output for a pulse-period duration of one at a power level of ¼ (arbitrarily assigned a relative output value of one over the image frame period). FIG. 15C illustrates the signals for a variable-power signal 22 of two (e.g., temporal bits T are zero and power bits P equal two or 10₂). In this case, power is output for a pulse-period duration of two at a power level of ¼ (a relative output value of two over the image frame period). FIG. 15D illustrates the signals for a variable-power signal 22 of three (e.g., temporal bits T are zero and power bits P equal three or 11₂). In this case, power is output for pulse-period durations equal to two and one at a power level of ¼ (a relative output value of three over the image frame period). FIG. 15E illustrates the signals for a variable-power signal 22 of four (e.g., temporal bits T are one or 001₂ and power bits P equal zero or 00₂). In this case, power is output for a pulse-period duration of one at a power level of 1 (a relative output value of four over the image frame period). FIG. 15F illustrates the signals for a variable-power signal 22 of five (e.g., temporal bits T are one or 001₂ and power bits P equal one or 01₂). In this case, power is output for a pulse-period duration of one at a power level of 1 and a pulse period duration of one at a power level of ¼ (a relative output value of five over the image frame period). FIG. 15G illustrates the signals for a variable-power signal 22 of six (e.g., temporal bits T are one or 001₂ and power bits P equal two or 10₂). In this case, power is output for a pulse period duration of two at a power level of 1 and a pulse period duration of two at a power level of ¼ (a relative output value of six over the image frame period). FIG. 15H illustrates the signals for a variable-power signal 22 of seven (e.g., temporal bits T are one or 001₂ and power bits P equal three or 11₂). In this case, power is output for a pulse period duration of two at a power level of 1 and pulse period durations of two and one at a power level of ¼ (a relative output value of seven over the image frame period).

FIG. 15I illustrates the signals for a variable-power signal 22 of eight (e.g., temporal bits T are two or 010₂ and power bits P equal zero or 00₂). In this case, power is output for a pulse period duration of two at a power level of one (a relative output value of eight over the image frame period). FIG. 15J illustrates the signals for a variable power signal 2 of nine (e.g., temporal bits T are two or 010₂ and power bits P equal one or 01₂). In this case, power is output for a pulse-period duration of two at a power level of 1 and a pulse period duration of one at a power level of ¼ (a relative output value of nine over the image frame period). FIG. 15K illustrates the signals for a variable-power signal 22 of ten (e.g., temporal bits T are two or 010₂ and power bits P equal two or 10₂). In this case, power is output for a pulse-period duration of two at a power level of 1 and a pulse period duration of two at a power level of ¼ (a relative output value of ten over the image frame period). FIG. 15L illustrates the signals for a variable-power signal 22 of eleven (e.g., temporal bits T are two or 010₂ and power bits P equal three or 11₂). In this case, power is output for a pulse-period duration of two at a power level of 1 and for pulse period durations of two and one at a power level of ¼ (a relative output value of eleven over the image frame period).

FIG. 15M illustrates the signals for a variable-power signal 22 of twelve (e.g., temporal bits T are three or 011₂ and power bits P equal zero or 00₂). In this case, power is output for pulse-period durations of two and one at a power level of 1 (a relative output value of twelve or eight plus four over the image frame period). FIG. 15N illustrates the signals for a variable-power signal 22 of thirteen (e.g., temporal bits T are three or 011₂ and power bits P equal one or 01₂). In this case, power is output for pulse-period durations of two and one at a power level of 1 and a pulse period duration of one at a power level of ¼ (a relative output value of thirteen or eight plus four plus one over the image frame period). FIG. 150 illustrates the signals for a variable-power signal 22 of fourteen (e.g., temporal bits T are three or 011₂ and power bits P equal two or 10₂). In this case, power is output for pulse-period durations of two and one at a power level of 1 and a pulse period duration of two at a power level of ¼ (a relative output value of fourteen or eight plus four plus two over the image frame period). FIG. 15P illustrates the signals for a variable-power signal 22 of fifteen (e.g., temporal bits T are three or 011₂ and power bits P equal three or 11₂). In this case, power is output for pulse-period durations of two and one at a power level of 1 and pulse period durations of two and one at a power level of ¼ (a relative output value of fifteen or eight plus four plus two plus one over the image frame period).

For cases in which temporal bit T₂ is high (on or enabled) or 1XX₂, FIGS. 15A-15P repeat with the addition of power output during temporal bit T₂ for four pulse periods at a power level of one, adding sixteen to the relative power over the image frame period.

FIGS. 14B-15P illustrate an embodiment with two P bits that provide 2^{P} (four) additional luminance levels to a pixel luminance value 92 and requires power (current) additionally supplied at ¼ power (current) with respect to power supplied to pulse periods corresponding to temporal bits T, and additional pulse periods P₁ and P₀, where P₁ has a temporal duration twice that of Po and the temporal duration of P₀ equals the temporal duration of T₀. In other embodiments, P equals three (to provide three extra bits) at the cost of three additional pulse periods equaling a temporal duration of seven additional least-significant bits, P equals four (to provide four extra bits at the cost of four additional pulse periods equaling a temporal duration of fifteen additional least-significant bits), P equals five (to provide five extra bits at the cost of five additional pulse periods equaling a temporal duration of thirty-one additional least-significant bits), P equals six (to provide six extra bits at the cost of six additional pulse periods equaling a temporal duration of sixty-three additional least-significant bits), or P equals other larger numbers of bits and 2^{P} additional power levels at the cost of P additional pulse periods equaling a temporal duration of 2^{P}−1 additional least-significant bits.

Embodiments of the present disclosure provide increased bit depth with simpler or smaller circuits. For example, in a conventional PWM design, if each pixel luminance signal 92 has 16 bits and the image frame rate is 480 frames per second, the frequency of pixel luminance signal 92 is nearly 32 MHz and the least significant bit has a corresponding control period of about 31 nanoseconds. This control period can be difficult or expensive to provide in a circuit on the substrate.

In contrast and according to embodiments of the present disclosure, if pixel luminance signal 92 is provided with temporal bits T and power bits P in a variable-power signal 22 that operates at different power levels for different pulses of a pulse-width modulation signal, circuit requirements and data rates can be reduced or additional bits added at the cost of a more complex power (current) supply or a slight reduction in image frame rate. For example, if each pixel luminance signal 92 has 16 bits, of which twelve are temporal in a twelve-bit PWM signal and four are power in a four-bit PWM signal as illustrated in FIGS. 15A-15P, and the image frame rate is 480 frames per second, then the least significant bit has a corresponding period of about 508 nanoseconds. For this example, the cost is an additional power source providing one sixteenth the power (current) supplied for the power bits P relative to the power (current supplied during the temporal bits T and a reduction in frame rate to 478 frames per second.

Thus, according to embodiments of the present disclosure a control circuit 14, e.g., a portion of a pixel controller 10, display controller 80, column controller 84, or cluster column controller 85, responds to a digital pixel luminance signal 92 for an image frame period to provide a timing signal 14A and control power signal 14B to a drive circuit 18 that is connected to and controls a light controller 20 (e.g., a light emitter such as an inorganic light-emitting diode 21) with a variable-power signal 22 (or pixel luminance signal 92). Variable-power signal 22 comprises temporal bits T and power bits P. Temporal bits T specify a pulse-width modulation signal with multiple pulse periods, for example periods with binary-weighted temporal durations. Likewise, power bits P specify a pulse-width modulation signal with multiple pulse periods, for example periods with binary-weighted temporal durations. A first power provided to light controller 20 during the pulse-width modulation pulse periods corresponding to the temporal bits T is different from a second power provided to light controller 20 during the pulse-width modulation pulse periods corresponding to the power bits P. For example, the second power can be one half, one quarter, one eight, one sixteenth, one thirty-second, or one sixty-fourth of the first power. Thus, in embodiments a control circuit 14 responds to a pixel luminance signal 92 to provide a first PWM signal for controlling a light controller 20 with a first power and a second PWM signal for controlling light controller 20 with a second power different from the first power. The first power is constant within each pulse period of the first PWM signal and the second power is constant within each pulse period of the second PWM signal. By constant is meant that the power for each pulse period is either zero or at a fixed non-zero power. The fixed non-zero power for the first PWM signal is different from the fixed non-zero power for the second PWM signal. The combined temporal duration of the first PWM signal and the second PWM signal can have a temporal duration that is perceived by the human visual system as a single light output period, e.g., an image frame period, that emits light at a constant luminance over the single light output period. Light-emitting diodes (LEDs) can be most efficient when driven at a specific current, as shown in FIG. 16 for given, red, green, and blue inorganic micro-light-emitting diodes. As shown in FIG. 16, a blue-light-emitting LED has a blue efficiency 71 with a blue efficiency maximum 71M, a green-light-emitting LED has a green efficiency 72 with a green efficiency maximum at 72M, and a red-light-emitting LED has a red efficiency 73 with a red efficiency maximum at 73M (off the current density scale of FIG. 14). Thus, in some embodiments, pixels (e.g., light controllers 20 or inorganic light-emitting diodes 21) emit light in response to current with an efficiency and emit light at different efficiencies in response to different currents. For example, pixels can emit light at a first luminance efficiency in response to a first current and emit light at a second luminance efficiency different from the first luminance efficiency in response to a second current different from the first current.

LED displays that change the current passing through the LEDs in each pixel to change the luminance of the LEDs will only operate at maximum efficiency at a specific luminance. Thus, such LED displays will only occasionally operate at maximum efficiency. LED displays that operate with desired currents (e.g., the maximum efficiency currents) can be limited in gray-scale resolution because their minimum pulse width 30 time period is too large at a desired image frame rate for a desired control circuit 14 design. According to embodiments of the present disclosure, hybrid pulse-width-modulation pixels 90 provide improved gray-scale resolution at a desired efficiency by operating at a more efficient constant current for first time periods and a less efficient constant current for second time periods, especially when the second time periods are fewer or shorter than the first time periods, or both fewer and shorter. Additional second time periods can be added to a pulse-width-modulation signal or pulse-width-modulation signals can be driven at different powers (e.g., different currents, voltages, or both). For example, in an eight-bit system with one power pulse, the power pulse is only active for one out of 128 pulse periods and, in a twelve-bit system with one power pulse, the power bit is only active for one out of 4096 pulse periods.

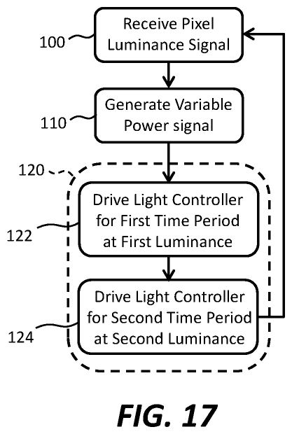

According to embodiments of the present disclosure and as illustrated in the flow diagram of FIG. 17, a method of operating hybrid pulse-width-modulation pixel 90 comprises receiving a pixel luminance signal 92 in step 100 by input circuit 12, generating variable-power signal 22 from pixel luminance signal 92 in step 110 by control circuit 14, driving light controller 20 with variable-power signal 22 for a first time period at a first luminance in step 122 by drive circuit 18, and driving light controller 20 with variable-power signal 22 for a second time period at a second luminance in step 124 by drive circuit 18. The second luminance can be different from the first luminance (unless they are both zero) and can correspond to different first and second powers used to drive light controller 20. The first and second time periods can have the same temporal duration or can have different temporal durations. The first time period can occur before the second time period, or the first time period can occur after the second time period, or the second time period can be provided during the first time period, e.g., between minimum pulse width 30 time period corresponding to a bit in the temporal bits T. Steps 122 and 124 can together drive a light-controller (step 120) having two phases or two portions. In some embodiments, the two portions can be a temporal portion and a power portion. In some embodiments, different powers are output during pulse periods corresponding to different temporal bits T.

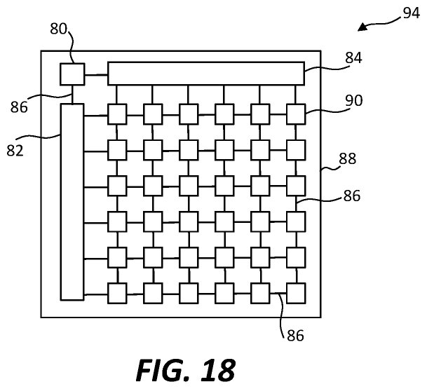

According to embodiments of the present disclosure and as shown in FIG. 18, a hybrid pulse-width-modulation-pixel display 94 comprises an array of hybrid pulse-width-modulation pixels 90 disposed on a display substrate 88 connected by wires 86 in an active-matrix configuration controlled by row controller 82 and column controller 84. Display controller 80 provides image data (image frames comprising an array of pixel data for display by the array of hybrid pulse-width-modulation pixels 90) to column controller 84. Row controller 82 selects rows of hybrid pulse-width-modulation pixels 90 and column controller 84 provides the pixel data to each hybrid pulse-width-modulation pixel 90 in the selected row.

Pixel luminance signal 92 can be provided to hybrid pulse-width-modulation pixel 90 by an external controller, for example a display controller 80, a row controller 82, or a column controller 84 connected to directly to hybrid pulse-width-modulation pixels 90 with wires 86, to rows of hybrid pulse-width-modulation pixels 90 with wires 86, or to columns of hybrid pulse-width-modulation pixels 90 with wires 86, respectively, for example as is found in active-matrix displays and as shown in FIG. 18. Pixel luminance signal 92 can be a digital signal.

Hybrid pulse-width-modulation-pixel display 94 can be a flat-panel display, for example an organic light-emitting diode display, an inorganic light-emitting diode 21 display, or a liquid crystal display. In some embodiments, switching frequencies are limited, for example by electronic devices and connections, or by switching frequencies for light controllers 20, for example liquid crystal displays that can have liquid crystal switching times in the tens of milliseconds. In such displays, a hybrid pulse-width-modulation-pixel display 94 can provide improved image frame rates or gray-scale resolution, or both.

Control circuits 14, input circuits 12, and drive circuits 18 can be constructed using analog or digital circuits, for example employing digital, analog, or mixed-signal integrated circuits disposed on a display substrate 88 or on pixel modules disposed on a display substrate 88.

Hybrid pulse-width-modulation-pixel display 94 can be a multi-color display with multiple different light controllers 20, for example red light-emitting diodes that emit red light, green light-emitting diodes that emit green light, and blue light-emitting diodes that emit blue light. Pixel luminance signal 92 can be a digital signal, for example a binary weighted digital signal and can comprise pixel data for each color of light emitted by hybrid pulse-width-modulation pixels 90, for example red, green and blue light emitted by corresponding the red, green, and blue light controllers 20. Pixel controller 10 can calculate variable-power signals 22 for each color of light and drive circuit 18 can provide power (e.g., current or voltage) signals to each light controller 20 in hybrid pulse-width-modulation pixels 90.

Light controller 20 can be any device or circuit that controls the emission of light from hybrid pulse-width-modulation pixel 90, for example a liquid crystal pixel with a backlight, an organic light-emitting diode pixel, or an inorganic light-emitting diode 21 pixel. Hybrid pulse-width-modulation pixel 90 can comprise multiple light controllers 20, for example a red-light controller that emits red light, a green-light controller that emits green light, and blue-light controller that emits blue light, collectively light controllers 20. Embodiments of the present disclosure can include one or more pixel controllers 10 that control multiple light controllers 20 and can receive multiple pixel luminance signals 92 for the multiple light controllers 20.

Light controllers 20 can be light-emitting diodes (e.g., inorganic light emitting diodes 21 such as micro-transfer printed micro-inorganic-light-emitting diode or organic light-emitting diodes) that can switch very rapidly between an on-state and an off-state (e.g., within a few micro-seconds, one micro-second, or less than a micro-second) in response to a digital control signal (e.g., either on at a fixed voltage and constant current emitting light or off and not emitting light at, for example, zero volts). The human visual system averages the light emitted during the minimum pulse width 30 time period in each display image frame to perceive an average brightness during the display frame if the pulses are sufficiently fast and short. In contrast, light emitters in displays driven by a variable voltage or variable current displays are on for the entire display frame but at a brightness dependent on the voltage or current supplied to the light emitters. Light-emitting diodes can have variable efficiency depending on the voltage or current supplied; thus light-emitting diodes driven at a constant current and voltage for variable amounts of time specified by temporal bits T, and according to embodiments of the present disclosure, can be more power efficient by operating at or near peak efficiency during the temporal pulses.

Inorganic light-emitting diodes (iLEDs) 21 can operate most efficiently at a given current. Moreover, different types of iLEDs or iLEDs that emit different colors of light can operate most efficiently at different constant currents or different voltages and can be driven at different constant currents for variable time periods. When light controller 20 is off, no current flows to light controller 20. When light controller 20 is on, ideally a constant, unvarying current at a fixed voltage flows to the operational light controller 20. According to some embodiments of the present disclosure, a PWM circuit can control each (e.g., respective) light controller 20 in each hybrid pulse-width-modulation pixel 90 in an active-matrix hybrid pulse-width-modulation-pixel display 94 comprising an array of hybrid pulse-width-modulation pixels 90, for example with a different desired constant current and voltage. When operational, light controller 20 emits light at a constant luminance. If light controller 20 is turned on and off quickly, the human visual system cannot perceive the switching and instead perceives a variable brightness depending on the amount of time the light emitter is on at the predetermined constant luminance.

Drive circuit 18 can comprise an effectively binary digital switch fed by a constant-current supply because it does not continuously modulate the amount of current supplied by the constant-current supply but rather operates in a first mode in which light controller 20 is turned off (e.g., at a zero voltage) and no current flows through light controller 20 and a second mode in which the current flows through light controller 20 at a designed constant current and non-zero voltage specified by the constant-current supply. The constant amount of current (or voltage) can be selected in response to power bits P and, depending on the circuit design, controlled by a current supply circuit controller 14, or drive circuit 18. Thus, the constant-current supply circuit has selectable constant currents that can be selected to provide various different desired constant currents. Drive circuit 18 does not function as an analog switch or amplifier and does not continuously modulate the current passing through light controller(s) 20, for example does not provide an amount of current greater than zero and less than the current supplied by the constant-current supply at whatever levels are specified by variable-power signal 22, within circuit design and manufacturing capabilities. Thus, the voltage and current supplied to light controllers 20 can be digital and binary (e.g., has two levels including zero) for temporal bits T, digital and binary pixel luminance signals 92 having a single power bit P not including zero, digital and quaternary for pixel luminance signals 92 having a two power bits P not including zero, and generally has 2^{P} power levels (not including zero) for pixel luminance signals 92 having P power bits. In some embodiments, power corresponding to temporal bits T can have two power levels, three power levels, four power levels, five power levels, or nine power levels (including zero).

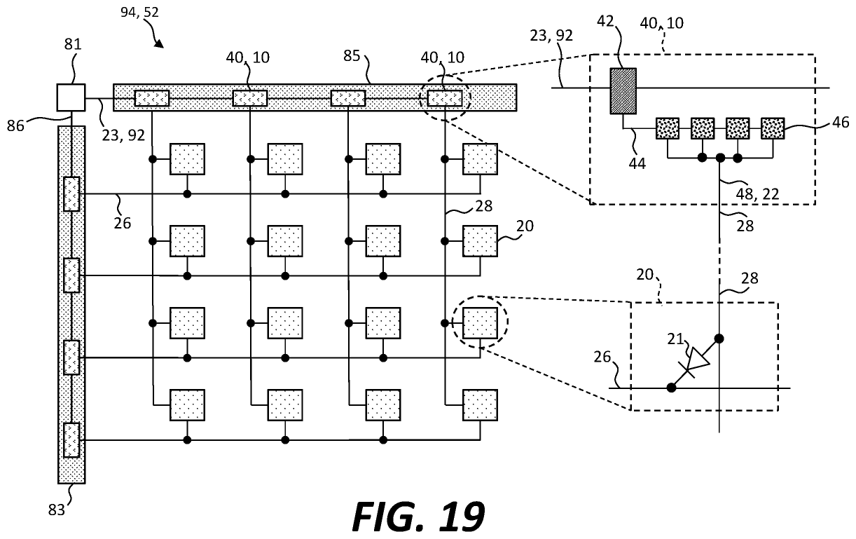

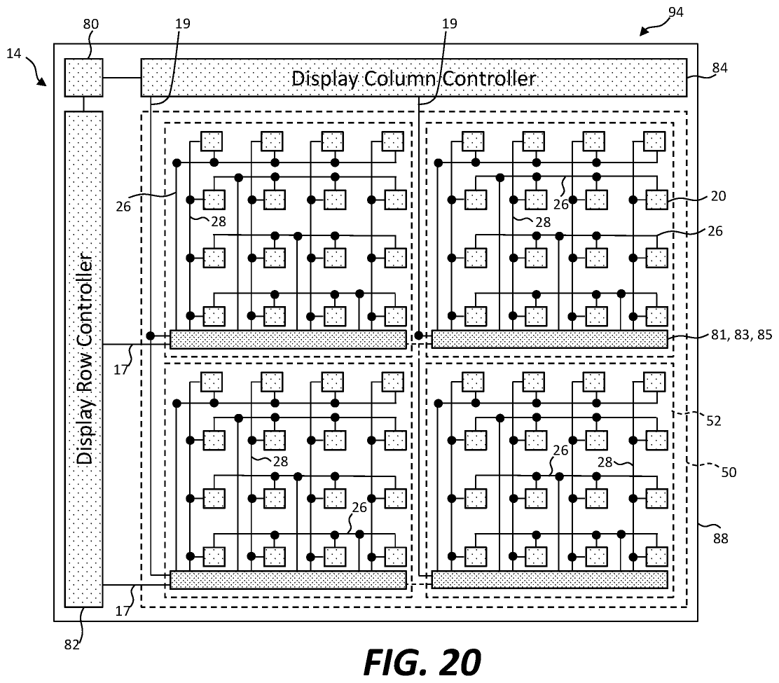

Certain embodiments of the present disclosure can be applied to active-matrix inorganic light-emitting diode 21 hybrid pulse-width-modulation-pixel displays 94. For example, display control signals from display controller 80 can comprise a row-control signal provided on a wire 86 connecting a row of pixels and a column-data signal provided on a wire 86 connecting a column of pixels and electrically connected to an array of hybrid pulse-width-modulation pixels 90 arranged in rows and columns on a display substrate 88 in an active-matrix hybrid pulse-width-modulation-pixel display 94. Each hybrid pulse-width-modulation pixel 90 can comprise one or multiple light controllers 20, each of which can comprise, for example, a micro-inorganic-light-emitting diode. Each of multiple light controllers 20 in a hybrid pulse-width-modulation pixel 90 can be or include a different inorganic light-emitting diode 21 that emits a different color of light when provided with electrical current at a suitable voltage. Hybrid pulse-width-modulation-pixel displays 94 of the present disclosure can be active-matrix displays with active-matrix hybrid pulse-width-modulation pixels 90 comprising pixel controllers 10 associated with each hybrid pulse-width-modulation pixel 90, as illustrated in FIG. 18. In some embodiments of the present disclosure, a hybrid pulse-width-modulation-pixel display 94 can be a passive-matrix display in which the functions and circuits of pixel controllers 10 are disposed in a passive-matrix column controller 85. As shown in FIG. 19, pixels (e.g., comprising light controllers 20, inorganic light-emitting diodes 21, or sub-pixels) are disposed in a two-dimensional array comprising rows and columns of light controllers 20. Each row of light controllers 20 can be uniquely connected to a different row wire 26 and each column of light controllers 20 can be uniquely connected to a different column wire 28 in the two-dimensional array of light controllers 20. Each row of light controllers 20 can be connected in common to a passive-matrix row controller 83 and each column of light controllers 20 can be connected in common to a passive-matrix column controller 85.

Passive-matrix column controller 85 can comprise column-control circuits 40. Each column-control circuit 40 is uniquely and separately connected to a different column wire 28 (generically, a wire 86) connecting a column of light controllers 20. Passive-matrix controller 81 can control passive-matrix row controller 83 that provides, for example, row-control signals on row wires 26 (generically, wires 86) to passive-matrix row controller 83. Passive-matrix controller 81 can also control passive-matrix column controller 85 and provide, for example, pixel luminance signals 92 (pixel luminance values 92) on pixel value wire 23 to passive-matrix column controller 85. Passive-matrix controller 81 can be a display controller 80 for a passive-matrix hybrid pulse-width-modulation-pixel display 94. Similarly, passive-matrix row controller 83 can be similar to row controller 82 except that passive-matrix row controller 83 provides passive-matrix row signals to rows of light controllers 20 on row wires 26 and passive-matrix column controller 85 can be similar to column controller 84 except that passive-matrix column controller 85 provides passive-matrix column signals to columns of light controllers 20 on column wires 28.

FIG. 19 illustrates a passive-matrix hybrid pulse-width-modulation-pixel display 94. In some embodiments of the present invention and as illustrated in FIG. 20, passive-matrix hybrid pulse-width-modulation-pixel display 94 comprises clusters 52 of light controllers 20 in a display area 50 on a display substrate 88. Clusters 52 of light controllers 20 are mutually exclusive so that each light controller 20 in a cluster 52 is a member of only one cluster 52 and all light controllers 20 are in a cluster 52. Each cluster 52 can provide passive-matrix control to a two-dimensional array of light controllers 20 in cluster 52 with each row of light controllers 20 uniquely and separately connected to a cluster row wire 26 and each column of light controllers 20 uniquely and separately connected to a cluster column wire 28. Thus, each cluster 52 can be an independent passive-matrix hybrid pulse-width-modulation-pixel display 94 as shown in FIG. 19. For example, FIG. 19 can illustrate a single passive-matrix hybrid pulse-width-modulation-pixel display 94 or can illustrate a cluster 52 in a multi-cluster 52 hybrid pulse-width-modulation-pixel display 94, as in FIG. 20. Thus, constant-current passive-matrix display 94 can comprise multiple constant-current passive-matrix arrays that are each a cluster 52.

Each cluster 52 of light controllers 20 can be controlled by a cluster controller 81. Cluster controller 81 can provide passive-matrix control to cluster 52 array of light controllers 20 and can comprise one or more integrated circuits, for example can comprise passive-matrix row controller 83 (e.g., a cluster row controller 83) and passive-matrix column controller 85 (e.g., a cluster column controller 85), as shown in FIG. 20. The passive-matrix hybrid pulse-width-modulation-pixel display 94 of FIG. 19 is essentially a display comprising a single cluster 52. Where passive-matrix hybrid pulse-width-modulation-pixel display 94 comprises multiple clusters 52 (e.g., as in FIG. 20), a display controller 80 can provide active-matrix row and column signals to rows and columns of clusters 52 (and to cluster controllers 81) through display row wires 17 (e.g., wires 86 of FIG. 18) connected to rows of clusters 52 and through display column wires 19 (e.g., wires 86 of FIG. 18) connected to columns of clusters 52 in a two-dimensional array of clusters 52.

Thus, embodiments of the present disclosure comprise a constant-current passive-matrix array comprising a two-dimensional array of pixels (e.g., each pixel comprising one or more light controllers 20 that emit one or more colors of light) disposed in pixel rows and pixel columns, all of the pixels in each pixel row connected in common to a row wire 26 and all of the pixels in each pixel column connected in common to a column wire 28. A row controller 82 (e.g., a display row controller or a cluster row controller 83) is connected to row wires 26 and is operable to select one of row wires 26 with a row-select signal. A passive-matrix column controller 85 (e.g., a display column controller or cluster column controller 85) is connected to column wires 28 and comprises a different column-control circuit 40 connected to each column wire 28. Each passive-matrix column controller 85 is operable to receive pixel values and provide a pixel value to each column-control circuit 40. In some embodiments, each of the pixels comprises multiple inorganic light-emitting diodes 21, for example that emit different colors of light such as red, green, and blue. Each inorganic light-emitting diode 21 can be selected with a common row-select signal on a common row wire 26 that emits light in response to different constant-current column-data signals 48 provided on separate column wires 28. Constant-current column-data signals 48 can be pulse-with modulation signals. Each passive-matrix column controller 85 comprises multiple column-control circuits 40. Each column-control circuit 40 is connected to a different column wire 28 and each passive-matrix column controller 85 is operable to receive multiple pixel values and provide a pixel value to each column-control circuit 40. Thus, a passive-matrix display can be a color display.

According to embodiments of the present disclosure, each column-control circuit 40 of passive-matrix column controller 85 (that is in some embodiments a cluster column controller 85 comprised in a cluster controller 81 of a cluster 52, for example as shown in FIG. 20) comprises a pixel controller 10 that receives pixel luminance signals 92. In a passive-matrix configuration, each pixel luminance signal 92 corresponds to the desired luminance of a light controller 20 connected to column-control circuit 40 in the row corresponding to a row of light controllers 20 selected by passive-matrix row controller 83 (e.g., cluster row controller 83 comprised in cluster controller 81). Each column-control circuit 40 then provides variable-power signal 22 corresponding to the light controller 20 selected by passive-matrix row controller 83 as specified by the pixel luminance signal 92. Variable-power signal 22 can comprise a power signal representing different amounts of power or current. For example, the power signal can be a digital binary power signal having one, two, three, four, five, or six bits.

In embodiments, each column-control circuit 40 comprises constant-current sources 46 (e.g., comprising two, four, eight, sixteen, thirty-two, or sixty-four constant-current sources 46) and a constant-current-source selection circuit 42 operable to individually and separately enable each of constant-current sources 46 in response to the pixel value with a constant-current-source selection signal 44, as shown in FIG. 19. The outputs of constant-current sources 46 are electrically connected in parallel to a column wire 28 and constant-current sources 46 are together operable to output a constant-current column-data signal 48 in response to constant-current-source selection signals 44.

Thus, according to embodiments of the present disclosure, variable-power signal 22 can be provided using multiple constant-current sources 46 whose outputs are electrically connected in parallel. Each constant-current source 46 in column-control circuit 40 can be individually and separately selected (enabled) for each pulse period of variable-power signal 22 and controlled by constant-current-source selection circuit 42 and can have a fixed power (current at a desired voltage) output that cannot be adjusted when selected and a zero current when not selected or enabled. Constant-current-source selection circuit 42 responds to variable-power signal 22 to provide a constant-current-source selection signal 44 applied to constant-current sources 46 that together provide constant-current column-data signal 48 to column wire 28 to which constant-current sources 46 and column-control circuit 40 are connected. Constant-current column-data signal 48 then provides constant current to light controller 20 of the selected row in the column of light controllers 20 to which column-control circuit 40 is connected for a desired pulse period, causing selected light controller 20 to emit light (if constant-current column-data signal 48 is not zero). The magnitude of the constant current provided to light controller 20 during the pulse period will depend on the number of constant-current sources 46 selected by constant-current-source selection circuit 42 in response to variable-power signal 22 derived from pixel luminance signal 92.

As discussed above, the constant current provided to selected light controller 20 is constant over a pulse period in a hybrid pulse-width modulation signal (e.g., for a temporal duration corresponding to T₀, T₁, etc.). However, according to embodiments of the present disclosure, the current provided during some pulses is different from the current provided during other pulses. For example, the current provided during the temporal periods can be different than the current provided during the power periods.

The different amounts of current can, according to embodiments of the present disclosure, be provided by multiple constant-current sources 46 whose outputs are electrically connected in parallel and individually enabled (selected) with a constant-current-source selection signal 44 provided by constant-current-source selection circuit 42 in response to pixel luminance signal 92 transmitted on pixel luminance wire 23. Thus, constant-current sources 46 together provide a single constant, substantially unchanging current during a first pulse period, but can provide a different constant current in a second PWM pulse different from the first pulse period. Constant-current sources 46 having various designs are known in the electrical arts and any suitable design can be used.

As illustrated, for example in FIGS. 9A-9D, a pixel luminance signal 92 of a pulse width modulation signal corresponding to a desired output luminance from a light controller 20 can comprise power bits that indicate one of several different desired luminances for light controller 20 for a given pulse period, for example a minimum pulse width corresponding to a least-significant bit period 30. Light controller 20 luminance during least-significant bit period 30 is controlled by the amount of current provided by constant-current sources 46 and, more specifically, by the total current provided by parallel-connected constant-current sources 46. Each constant-current source 46 provides either no current (when it is not enabled by constant-current-source selection signal 44) or a constant unvarying current (when it is enabled by constant-current-source selection signal 44) over the pulse time. By selecting (enabling) desired constant-current sources 46 connected to a common column wire 28, different desired currents can be provided to selected light controller 20 and hence the desired luminance from selected light controller 20.

Constant-current sources 46 can be identical or have substantially similar sizes and power or current output. For example, a transistor of a given size (e.g., area) can conduct a certain current. Constant-current sources 46 comprising transistors of substantially the same size (e.g., area) can provide substantially the same power or current, for example as shown in FIG. 19. Thus, a first constant-current source 46 in each column-control circuit 40 can have a first size (e.g., area) and provide a first current and a second constant-current source 46 in each column-control circuit 40 can have a second size (e.g., area) and provide a second current that is equal to the first current.

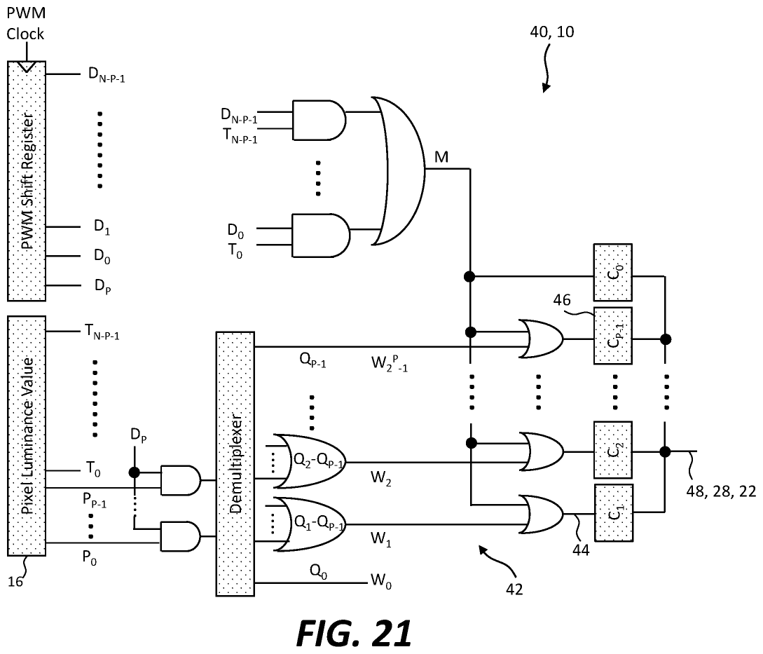

FIG. 21 illustrates embodiments of column-control circuits 40 in which multiple constant-current sources 46 having substantially the same sizes source substantially the same current when enabled. Digital binary logic designers, among others, will readily appreciate that embodiments such as those of FIG. 21 are illustrative and not limiting; many other designs providing the same functionality are possible and embodiments of the present disclosure are not limited by the illustrations and examples provided in the present disclosure. The FIG. 21 design is intended to clearly explicate the function of column-control circuit 40, not necessarily to optimize performance or circuit size.

As shown in FIG. 21, a pixel luminance value 92 (having N bits including T temporal bits and P power bits) corresponding to a desired light output from a selected light controller 20 is stored in memory 16. A PWM shift register responsive to a PWM clock that signals the beginning of each binary-weighted pulse period shifts a bit through the register and provides a separate output D that is active (e.g., high) for each individual pulse period in turn. Each of the different outputs D_{N-P-1} through D₀ are activated in turn by the PWM shift register and are each combined with the corresponding temporal bit T of the N-bit pixel luminance value 92 in memory 16 with an AND gate. Thus, each “one” temporal bit provides an on (high, positive) output M for the corresponding PWM pulse period. The pixel luminance value 92 corresponding to the last of the T pulse periods D₀ of the PWM cycle has a least-significant bit T₀ after which the last pulse period D₀ is repeated (the PWM clock repeats the LSB period duration) to provide a D_{P} pulse equal in duration to the D₀ pulse period during which the power bits are output. If multiple binary-weighted pulse periods are used for power bits P (e.g., as shown in FIGS. 14A-15P) additional D_{P} pulses of corresponding period can be provided. The PWM clock can have binary-weighted intervals corresponding to the pulse periods.

Each of the temporal bits in memory 16 is combined with the corresponding sequentially accessed pulse period signal D with an AND gate and the combination is input to a single OR gate. The output M of the OR gate is on (high) whenever any temporal bit is on (high) and is input to an OR gate for each and every constant-current source 46. Thus, if any temporal bit T is on (high) during a corresponding pulse period, all of the constant-current sources 46 are enabled and output their combined current as constant-current column-data signal 48 on column wire 28. All of the constant-current sources 46 are turned on together (acting as a single combined constant-current source 46) for a pulse period D if the corresponding temporal bit T is high during the temporal output phase D (indicated by signal M). This portion of the process can functionally correspond to a conventional pulse-width modulation output for the temporal bits T.

Once all of the temporal bits T are output, including the LSB T₀ for period D₀, (the least-significant bit and shortest pulse period), the PWM clock is triggered for another pulse D_{P} having a duration equal to that of D₀ during which a current corresponding to the value of the P power bits is output as constant-current column-data signal 48. Each bit of the P power bits is simultaneously selected with an AND gate responsive to signal P (of the PWM shift register) as an input to a demultiplexer that takes the P power bits as an input and provides a separate signal for each of the possible values of the P power bits.

In the embodiment of FIG. 21, each of constant-current sources 46 have substantially similar current output and constant-current column-data signal 48 responds linearly to changes in the value of the P power bits so that each incremental change in value of the P power bits corresponds to the same change in constant-current column-data signal 48 and variable-power signal 22. To achieve this, variable-power signal 22 must provide a different value for each of the P power bits and drive circuit 18 must comprise 2^{P} constant-current sources 46, of which 2^{P}−1 are controlled by the power bits. (The remaining constant-current source 46 is only used for the temporal bits.) For example, if P equals 2 power bits (representing values 0, 1, 2, and 3), drive circuit 18 must have 2²=4 constant-current sources 46 of which 2²−1=3 constant-current sources 46 are partly controlled by the power bits. If there are three power bits P, drive circuit 18 must have 2³=8 constant-current sources 46 of which 2³−1=7 constant-current sources 46 are party controlled by the power bits P. If there are four power bits P, drive circuit 18 must have 2⁴=16 constant-current sources 46 of which 2⁴−1=15 constant-current sources 46 are partly controlled by the power bits. The OR gates incrementally combine demultiplexed bits so that, if the MSB bit is on, all of the 2^{P}−1 constant-current sources 46 are enabled, if the MSB-1 bit is on, all but one of the 2^{P}−1 constant-current sources 46 are enabled, and so on until the LSB bit only enables one of the constant-current sources 46.

As shown in FIG. 21, each of constant-current sources 46 is enabled with a constant-current-source selection signal 44 that combines the demultiplexer outputs W. If W₀ is active, the P power bits are all zero and no constant-current sources 46 are enabled with a constant-current-source selection signal 44. If any of W₁ through W_{P-1} is active (determined by an OR gate), a first constant-current source 46 (C₁) is enabled. If any of W₂ through W_{P-1} is active (determined by an OR gate), a second constant-current source 46 (C₂) is enabled and so on. Only if power bits P represent the maximum value (all bits are one) is the last constant-current source 46 enabled. Thus, as the value of the power bits P increases from zero to the maximum of all ones by one at a time, constant-current source 46 are each turned on one at a time to provide a current output linearly corresponding to the value of the P power bits.

The embodiments of FIG. 21 comprise constant-current sources 46 that each provide substantially the same current. The current supplied by a constant-current source 46 can depend on the size of the constant-current source 46 (e.g., by a transistor and specifically the length of the interface between a source and a drain in a transistor). Thus, larger constant-current sources 46 can provide greater current and, if the sizes correspond to a binary-weighted sequence (e.g., the sizes are related by powers of two), fewer constant-current sources 46 and less logic are needed (although the total area occupied by the fewer constant-current sources 46 can be the same as for embodiments having constant-current sources 46 that are all the same size).

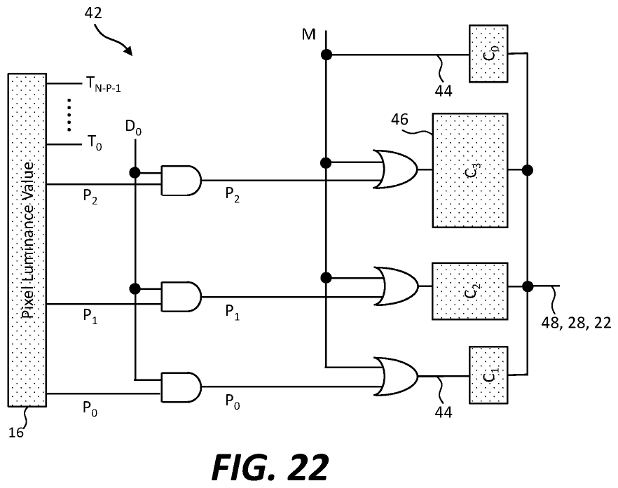

FIG. 22 illustrates embodiments with P=3 (three power bits representing eight values from zero through seven) that comprise three constant-current sources 46 that have binary-weighted sizes and source binary-weighted currents (e.g., each constant-current source 46 provides twice or one-half the current of another constant-current source 46) or power. An additional LSB constant-current source 46 controlled by signal M is provided to enable the total current output corresponding to the desired output for the temporal bits T. In the FIG. 22 illustration, three power bits P (P₀, P₁, P₂) specify eight (2³) different current levels including zero. In embodiments, any number of power bits P greater than one can be used. The number of constant-current sources 46 corresponds to the number of power bits P plus one. As shown in FIG. 22, each power bit P (when enabled by signal D_{P}) controls constant-current source 46 having a size corresponding to the binary place of the power bit (e.g., power bit 0 enables the smallest constant-current source 46, power bit 1 enables a constant-current source 46 twice the size of the smallest constant-current source 46, and power bit P_{P-1} controls the largest constant-current source 46 (e.g., P₂ in this example). In this example, if all of the power bits P are zero, none of the constant-current sources 46 are enabled (when in power bit output mode specified by D_{P} on, so that M is low or zero). When D_{P} is one, if bit P₀ is one (high), the smallest constant-current source 46 C₀ is enabled, if bit P₁ is one (high) constant-current source 46 C₁ is enabled, if bit P₂ is one (high) constant-current source 46 C₂ is enabled, and so forth.

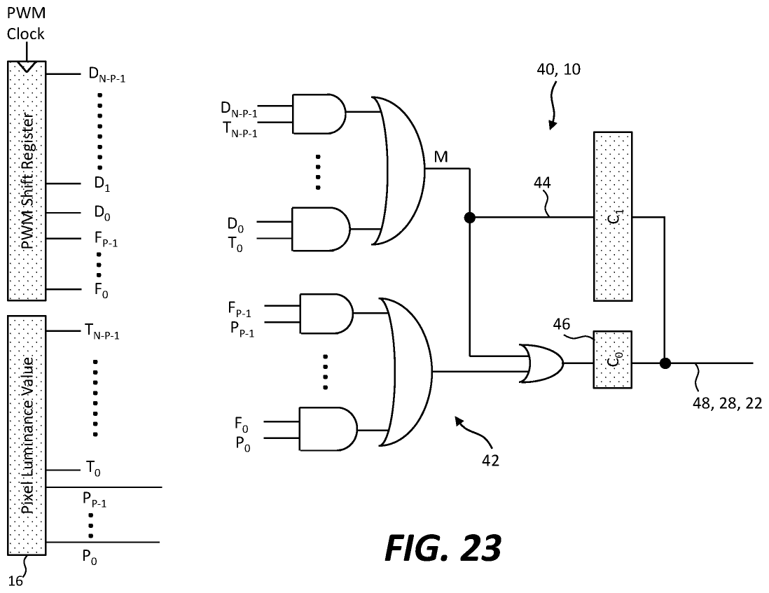

In some embodiments, such as those of FIGS. 14A-15P, only two different power levels (different currents) are used or needed for variable-power signal 22. For example, if power levels of one and ¼ are required, two different constant-current sources 46 can be used, one providing a ¾ and one providing a ¼ power level. When both are enabled, a relative power of one is provided; if only the smaller is enabled, a relative power of ¼ is provided. Circuits similar to those of FIG. 21 (with four equal-sized constant-current sources 46) or FIG. 22 (with two constant-current sources 46, one three times the size of the other) can be used. FIG. 23 illustrates embodiments with two constant-current sources 46, one (C₁) three times the size of the other (C₀). The PWM shift register of FIG. 21 can have a bit for each of both the temporal bits T and power bits P with corresponding PWM clock intervals and a power-bit control similar to the temporal bit control (rather than using a demultiplexer or binary-weighted current-sources 46). As shown, whenever a bit T is enabled for a period D, both constant-current sources (C₁ and C₀) are enabled. Whenever a bit P is enabled for a period F, only one constant-current source 46 (C₀) is enabled. In some embodiments, a separate constant-current source 46 is used for temporal bits T and power bits P (providing the desired different power or current for each).

Table 1 provides a numerical example of embodiments of the present disclosure. Pixel luminance value 92 has three bits so N=3 and pixel luminance value 92 can have 2^{N} (2³=8) different values ranging from zero to seven (2³−1) over (2³−1=7) temporal pulse periods (typically arranged in binary-weighted groups equivalent to four, two, and one minimum (LSB) pulse periods). A single constant-current source 46 as shown in a conventional PWM design, can provide a desired current (when on) or no current (when off). Thus, at maximum output constant-current source 46 provides the constant current for seven periods for a total current (and light) output of seven (in arbitrary units) over seven periods (of arbitrary length (but chosen to prevent perceptible flicker) for an efficiency of (seven/seven) or 100%.

TABLE 1
Design for N = 3 (pixel luminance value)
Conventional PWM:

| | |
|---|---|
| Output range: | 2³ = 8 (values 0, 1, 2, 3, 4, 5, 6, 7) |
| Total periods: | 7 = (2³ − 1) |
| Current sources: | 1 |
| Efficiency: | 100% (max current/# periods = 7/7) |

Embodiments with 3 temporal bits (T) and 2 power bits (P):

| | |
|---|---|
| Output range: | 2⁵ = 32 (values 0, 1, 2, . . . 31) |
| Total periods: | 8 = (2³ − 1) + 1 power bit |
| Current sources: | 2^{P} = 4 |
| Efficiency: | ~97% (max current/# periods = 7¾/8) |

In contrast, embodiments of the present disclosure as shown in Table 1 can use an additional pulse period to provide P (two) power bits so that there are a total of 8 pulse periods (arranged in groups of four, two, and one temporal periods plus the additional power pulse period, the additional power pulse period having a temporal duration of one or the duration of the output of a least-significant bit of the N-bit pixel luminance value 92). Constant-current sources 46 with outputs connected in parallel can provide 0, 1, 2, or 3 levels of current (and hence different luminances from light controller 20) during the power bit P period. Constant-current sources 46 together have a total current output equal to the one constant-current source 46 during the temporal bit T periods of the conventional PWM example, e.g., each having a current output ¼ of the constant-current source 46 of the conventional PWM example. Maximum output responsive to a maximum N-bit pixel luminance value 20 with two power bits (all bits on) is 7¾ over eight pulse periods (seven for the temporal pulse periods plus ¾ for the power pulse period) or about 97%. This efficiency value does not account for any reduced efficiency due to power-bit output at lower currents. Note that, if power bits were employed with a single constant-current source 46, they would also be operated at different currents and could have reduced efficiency (see FIG. 16).

Table 2 provides a numerical example of embodiments of the present disclosure similar to that of FIG. 22 but with more bits. As shown in Table 2, pixel luminance value 92 has twelve bits so N=12 and pixel luminance value 92 can have 2^{N} (2¹²) different values ranging from zero to 4095 (2¹²−1) over (2¹²−1=4095) temporal pulse periods (typically arranged in binary-weighted groups of 2048, 1024, 512, 256, 128, 64, 32, 16, 8, 4, 2, and 1). A single constant-current source 46 as in a conventional PWM design can provide a desired current (when on) or no current (when off). Thus, at maximum output constant-current source 46 provides the constant current for 4095 periods for a total current (and light) output of 4095 (in arbitrary units) over 4095 periods (of arbitrary length but chosen to prevent perceptible flicker) for an efficiency of (4095/4095) or 100%.

TABLE 2
Design for N = 12 (pixel luminance value)
Conventional PWM:

| | |
|---|---|
| Output range: | 2¹² = 4096 (values 0, 1, 2, . . . 4095) |
| Total periods: | 4095 = 2¹² − 1 |
| Current sources: | 1 |
| Efficiency | 100% (max current/# periods = 4095/4095) |

Embodiments with 12 temporal bits (T) and 4 power bits (P):

| | |
|---|---|
| Output range: | 2¹⁶ = 65,536 (values 0, 1, 2, . . . 65,535) |
| Total periods: | 4096 = (2¹² − 1) + 1 power bit |
| Current sources: | 2^{P} = 16 |
| Efficiency: | ~99.99% (max current/# periods = (4095 15/16)/4096) |

In contrast, embodiments of the present disclosure as shown in Table 2 can use an additional pulse period to provide P (four) power bits so that there are a total of 4096 pulse periods (arranged in groups of 2048, 1024, 512, 256, 128, 64, 32, 16, 8, 4, 2, and 1 temporal periods plus the additional power pulse period, the additional power pulse period having a temporal duration of one or the duration of the output of a least-significant bit of the N-bit pixel luminance value 92). Constant-current sources 46 with outputs connected in parallel can provide 0, 1, 2, 3, 4, 5, 6, 7, 8, 9, 10, 11, 12, 13, 14, or 15 levels of current in combination with any of the T temporal periods during which all 16 constant-current sources 46 are on, providing 65536 different luminances from light controller 20) during the PWM cycle. In some embodiments, constant-current sources 46 together have a total current output equal to the one constant-current source 46 of the conventional PWM example, e.g., each having a current output 1/16 of the constant-current source 46 of the conventional PWM example. Therefore, maximum output responsive to a maximum N-bit pixel luminance value 20 with four power bits (all bits on) is 4095 15/16 over 4096 pulse periods (4095 for the temporal pulse periods plus 15/16 for the power pulse period) or about 99.99%. As with the example of Table 2, this efficiency value does not account for any reduced efficiency due to power-bit output at lower currents. If power bits were employed with a single constant-current source 46, they would also be operated at different currents and could have reduced efficiency (see FIG. 16).

FIG. 16 demonstrates that inorganic micro-LEDs can operate at best efficiency at a particular current density. If constant-current sources 46 are together designed to provide currents that operate light controller 20 at the most-efficient current density, when fewer than all of the constant-current sources 46 are enabled (e.g., during the power period P), light controllers 20 can operate at a reduced efficiency. For example, blue efficiency 71 has a maximum at blue efficiency maximum 71M of about 21% at a current density of approximately 28 A/cm². If operated at one half that current density, e.g., 14 A/cm², the efficiency drops to about 20.5% and, at one quarter current density, e.g., 7 A/cm², the efficiency is about 19%, and at one eighth current density, e.g., 3.5 A/cm², the efficiency is about 17%.

In a simple case with two parallel-connected constant-current sources 46 (P=1) of equal size (e.g., area), if only one constant-current source 46 is enabled, the actual relative efficiency is about 97.62% (=20.5/21) and the actual luminance output of light controller 20 would be similarly reduced. However, and according to embodiments of the present disclosure, if one of the two constant-current sources 46 output (e.g., constant-current source 46 size) is adjusted to provide more current than the other, the luminance can be corrected so that the actual luminance (current) provided by the one constant-current source 46 is one half that of the two constant-current sources 46 together. In this example, two constant-current sources 46 (P=1) can be provided and are electrically connected in parallel to provide a luminance of two (for simplicity and in arbitrary units) when both are enabled. When both are off, no current is provided. If P₀=1, only one of the two constant-current sources 46 is enabled. If the one constant-current source 46 has a relative area (size) of about 1.0244 (21/20.5) and the other has a size of 0.9762, then together the two constant-current sources 46 will still provide the desired current (luminance) of two (because 1.0244+0.9762=2) but if only the larger is enabled, they will provide a luminance of (1.024*0.9762)=1, thereby correcting for the reduced efficiency of the smaller current (but still operating at that reduced efficiency).

The relative constant-current source 46 sizes can accommodate an arbitrary number of power bits P. In another example P=2 for four constant-current sources 46 electrically connected in parallel. When all four constant-current sources 46 are enabled (e.g., during temporal bits T output), four constant-current sources 46 (arbitrarily labelled A, B, C, and D) can provide an arbitrary current and luminance of four (the maximum current, current density, and luminance). When P=1 (01₂), one constant-current source 46 A is enabled and the desired output is one (e.g., ¼ of maximum), when P=2 (10₂), two constant-current sources 46 A and B are enabled and the desired output is two (e.g., ½ of maximum), and when P=3 (11₂), three constant-current sources 46 A, B, and C are enabled and the desired output is three (e.g., ¾ of maximum). However, if A, B, C, and D all provide the same current, because the output efficiency at the lower currents is reduced, the actual output from combinations of A, B, and C is lower than desired. This can be corrected by adjusting the relative sizes (area) of constant-current sources 46.

Assuming that the efficiency E_{ABC} from A, B, and C together is (20.75/21) %, the efficiency E_{AB} from A and B together is (20.5/21) %, and the efficiency E_{A} of A is (19/21) %, then A has a size of 1.105263 (equal to 1/E_{A}). B then has a size of 0.943517 (equal to 2/E_{AB}−A), C has a size 0.987364 (equal to 3/E_{ABC}−A−B), and D has a size of 0.963855 (equal to 4−A−B−C, the efficiency of A+B+C+D is 100%). Thus, the output from (A+B+C+D) is 4, the output from A, B, and C together is 3 (¾ of 4) at the reduced efficiency of E_{ABC}, the output from A, and B together is 2 (½ of 4) at the reduced efficiency of E_{AB}, and the output of A is 1 (¼ of 4) at the reduced efficiency of E_{A}, all as desired.

The example above illustrates changes in current source capacity (current source size (e.g., area)) for constant-current sources 46 that would be the same size if the different combinations for constant-current sources 46 had the same efficiency, e.g., corresponding to embodiments such as the example shown in FIG. 21). The same modifications can be applied to embodiments in which constant-current sources 46 would have binary-weighted sizes if the constant-current sources 46 had the same efficiency, e.g., corresponding to embodiments such as the example shown in FIG. 22). However, because combinations of constant-current sources 46 comprising less than all of the constant-current sources 46 can have reduced efficiency compared to all of the constant-current sources 46 and therefore provide less than desired luminance from light controller 20, by adjusting the current source capability (e.g., size (e.g., area)) of some of the constant-current sources 46, the substantially desired luminance can be achieved.

In another example with P=2, three constant-current sources 46 A, B, C are used. A has a size of approximately one, B has a size of approximately two, and C has a size of approximately four. When all of A, B, and C are enabled, the desired output is four at an efficiency of one. The efficiency at current of ¼, and ½, and ¾ are as described above.

The relative size of A is the same as above and the relative size of B is 2.048780 (equal to 2/E_{AB}. The output from A alone is 1 (equal to A times E_{A}), the output from B alone is 2 (equal to B times E_{AB}), and the output of all three is 4, all as desired. However, the output from A and B together (equal to a power value of 3 (11₂) is 3.116496, greater than desired, because the efficiency of the combination of A and B is greater than the efficiency of either alone. If desired, the sizes of A or B, or both can be reduced to make the output of the combination of A and B closer to the desired value, but at the expense of making the output of either A and B, or both, different from the desired value. Smaller errors in outputs from multiple constant-current sources 46 can be preferred to a greater error in one constant-current source 46 output.

The adjusted sizes as described above are relative values for a specific desired constant-current source 46 size for a specific light controller 20 at a specific desired luminance. In actual practice, the relative sizes can be multiplied by a factor that results in an absolute size that is desired or required (e.g., based on processing limitations). Since the luminance efficiency of different light controllers 20 (e.g., different inorganic light-emitting diodes that emit different colors of light) can be different, the relative sizes of constant-current sources 46 for each type of light controller 20 can be different. Generally, a first constant-current source 46 can provide a first current or has a first size (e.g., first area) that is no more than 20% (e.g., 10%, 5%, or 1%) larger than a second current provided by a second constant-current source 46 or than a second size (e.g., second area) of second constant-current source 46. Similarly, a first constant-current source 46 can provide a first current or has a first size (e.g., first area) that is no more than 220% (e.g., 210%, 205%, or 201%) larger than a second current provided by a second constant-current source 46 or than a second size (e.g., second area) of second constant-current source 46.

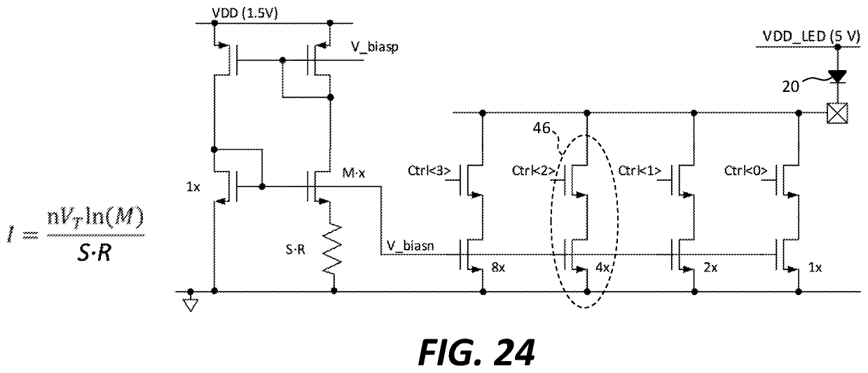

A variety of constant-current sources 46 can be used in embodiments of the present disclosure, as will be understood by those knowledgeable in electronic circuit design. FIG. 24 illustrates four constant-current sources 46 of a common size (P=2) biased in the sub-threshold region each of whose current output is controlled by resistor R. Constant-current sources 46 zero through three are controlled by transistor gate signals Ctrl<x>where x ranges from 0 to 3 and can share circuit components (e.g., resistor R). As illustrated in the equation, R can be scaled linearly to control the bias current. Larger resistors reduce the current by a corresponding factor. In a specific implementation, the resistors are fixed in size and the current from each constant-current source 46 is likewise fixed. A variable-power signal 22 is provided by selecting various numbers of the constant-current sources 46. The FIG. 24 illustration corresponds to embodiments according to FIG. 21. If the transistors have different sizes (e.g., binary weighted as shown), constant-current sources 46 can correspond to FIG. 22. If the different constant-current source 46 transistors each have a size modified by the current-and-luminance efficiency of light controller 22, embodiments such as those described with respect to FIGS. 24 and 25 can be implemented, including size (e.g., area) adjustments to accommodate variations in light controller 20 efficiency at different currents. Generally, the number of transistors and their relative sizes can be adjusted to support various ones of the disclosed embodiments.

Another design option, not shown, scales the bias voltage V_biasn in FIG. 24 by using a current mirror to scale the P-side bias using a PMOS transistor that is ¼ the size of the ones shown in the bias block.

According to some embodiments of the present disclosure, pixel controller 10 can comprise any of a variety of transistors, for example transistors such as those known in the electronics, integrated circuit, and display industries. Transistors can be thin-film transistors (TFTs), for example amorphous transistors or polysilicon transistors and can be a semiconductor thin-film circuit formed on a substrate, such as a display substrate 88. In some embodiments, transistors are crystalline silicon or compound semiconductor transistors, for example made in an integrated circuit process and can be transfer printed onto a display substrate 88 or onto a pixel module substrate that is transfer printed onto display substrate 88. Such transfer-printed structure can comprise fractured or separated tethers. Embodiments of the present disclosure, comprise a substrate on which clusters 52 are disposed and wherein the cluster row controller 83 and cluster column controller 85 are disposed between pixels on the substrate.

According to some embodiments of the present disclosure, light controllers 20 are micro-inorganic-light-emitting diodes (micro-iLEDs) with at least one of a width and a length that is no greater than 500 microns (e.g., no greater than 200 microns, no greater than 100 microns, no greater than 50 microns, no greater than 25 microns, no greater than 15 microns, no greater than 12 microns, no greater than 8 microns, or no greater than 5 microns). Micro-LEDs provide an advantage according to some embodiments of the present disclosure since they are sufficiently small and can be disposed spatially close together so that the different micro-LEDs in a hybrid pulse-width-modulation pixel 90 cannot be readily distinguished by the human visual system in a display at a desired viewing distance, improving color mixing of light emitted by hybrid pulse-width-modulation pixel 90 and providing apparent improvements in display resolution. Embodiments of the present disclosure can be constructed using micro-transfer printing.

Methods of forming useful micro-transfer printable structures are described, for example, in the paper AMOLED Displays using Transfer-Printed Integrated Circuits, Journal of the SID, 19(4), 2012, and U.S. Pat. No. 8,889,485. For a discussion of micro-transfer printing techniques see, U.S. Pat. Nos. 8,722,458, 7,622,367 and 8,506,867, the disclosures of which are hereby incorporated by reference in their entirety. Micro-transfer printing using compound micro-assembly structures and methods can also be used with the present disclosure, for example, as described in U.S. patent application Ser. No. 14/822,868, filed Aug. 10, 2015, entitled Compound Micro-Assembly Strategies and Devices, the disclosure of which is hereby incorporated by reference in its entirety. In some embodiments, pixels are compound micro-assembled devices.

As is understood by those skilled in the art, the terms “over” and “under”, “above” and “below”, and “top” and “bottom” are relative terms and can be interchanged in reference to different orientations of the layers, elements, and substrates included in the present invention. For example, a first layer on a second layer, in some implementations means a first layer directly on and in contact with a second layer. In other implementations a first layer on a second layer includes a first layer and a second layer with another layer therebetween.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as operability is maintained. Moreover, two or more steps or actions in some circumstances can be conducted simultaneously.

Having expressly described certain embodiments, it will now become apparent to one skilled in the art that other embodiments incorporating the concepts of the disclosure may be used. Therefore, the claimed invention should not be limited to the described embodiments, but rather should be limited only by the spirit and scope of the following claims.

### PARTS LIST

B bit of multiple bits
P power bit
T temporal bit
10 pixel controller
12 input circuit
14 control circuit
14A timing signal
14B control power signal
16 memory
17 display row wire
18 drive circuit
19 display column wire
20 light controller
21 inorganic light-emitting diode
22 variable-power signal
23 pixel luminance value wire
26 row wire/cluster row wire/row-select signal
28 column wire/cluster column wire/column-data signal
30 minimum pulse width/least-significant bit period
40 column-control circuit
42 constant-current-source selection circuit
44 constant-current-source selection signal
46 constant-current source
48 constant-current column-data signal
50 display area
52 cluster
71 blue efficiency vs. current density/blue efficiency
71M blue efficiency maximum
72 green efficiency vs. current density/green efficiency
72M green efficiency maximum
73 red efficiency vs. current density/red efficiency
73M red efficiency maximum
80 display controller
81 passive-matrix controller/cluster controller
82 row controller
83 passive-matrix row controller/cluster row controller
84 column controller
85 passive-matrix column controller/cluster column controller
86 wire
88 display substrate
90 hybrid pulse-width-modulation pixel
92 pixel luminance signal/pixel luminance value
94 hybrid pulse-width-modulation-pixel display
100 receive pixel luminance signal step
110 generate variable power signals step
120 drive light controller step
122 drive light controller for first time period at first luminance step
124 drive light controller for second time period at second luminance step

1. A constant-current passive-matrix array, comprising:
a two-dimensional array of pixels disposed in pixel rows and pixel columns, wherein, for each of the pixel rows, all of the pixels in the pixel row are connected in common to a row wire and, for each of the pixel columns, all of the pixels in the pixel column are connected in common to a column wire;
a row controller connected to the row wire for each of the pixel rows, the row controller operable to select the row wire for one of the pixel rows with a row-select signal; and
a column controller connected to the column wire for each of the pixel columns,
wherein, for each of the column wires,
the column controller comprises a respective column-control circuit connected to the column wire,
the column controller is operable to provide a pixel value to the respective column-control circuit connected to the column wire,
the respective column-control circuit comprises constant-current sources and a constant-current-source selection circuit operable to individually and separately enable each of the constant-current sources with a constant-current-source selection signal in response to the pixel value, and
outputs of the constant-current sources are electrically connected in parallel to the column wire and the constant-current sources are together operable to output a constant-current column-data signal in response to the constant-current-source selection signal.

2. The constant-current passive-matrix array of claim 1, wherein each of the pixels comprises an inorganic light-emitting diode selectable with a row-select signal, wherein the inorganic light-emitting diode emits light in response to a constant-current column-data signal.

3. The constant-current passive-matrix array of claim 2, wherein each of the pixels comprises multiple inorganic light-emitting diodes, each of the inorganic light-emitting diodes selectable with a common row-select signal on a common row wire, and each of the inorganic light-emitting diodes emits light in response to different constant-current column-data signals provided on separate column wires.

4. The constant-current passive-matrix array of claim 3, wherein the multiple inorganic light-emitting diodes in each of the pixels are operable to emit different colors of light.

5. The constant-current passive-matrix array of claim 1, wherein the constant-current sources in the respective column-control circuit each provide a substantially same amount of current.

6. The constant-current passive-matrix array of claim 1, wherein the constant-current sources in the respective column-control circuit have a substantially same size

7. The constant-current passive-matrix array of claim 1, wherein the constant-current sources in the respective column-control circuit are operable to provide substantially binary-weighted amounts of current.

8. The constant-current passive-matrix array of claim 1, wherein the constant-current sources in the respective column-control circuit have substantially binary-weighted sizes or have substantially binary-weighted areas.

9. The constant-current passive-matrix array of claim 1, wherein the pixels emit light in response to current with an efficiency and emit light at different efficiencies in response to different currents.

10. The constant-current passive-matrix array of claim 1, wherein a first constant-current source in the respective column-control circuit has a first size and is operable to provide a first current and a second constant-current source in the column-control circuit has a second size and is operable to provide a second current that is equal to the first current.

11. The constant-current passive-matrix array of claim 1, wherein the pixels emit light at a first luminance efficiency in response to a first current and emit light at a second luminance efficiency different from the first luminance efficiency in response to a second current different from the first current, and
wherein a first constant-current source in the respective column-control circuit (i) is operable to provide a current and/or (ii) has a size corresponding to the first luminance efficiency and a second constant-current source in the respective column-control circuit (i) is operable to provide a current and/or (ii) has a size corresponding to the second luminance efficiency.

12. The constant-current passive-matrix array of claim 11, wherein the first constant-current source is operable to provide a first current and/or has a first size that is no more than 20% larger than a second current provided by the second constant-current source during operation and/or than a second size of the second constant-current source.

13. The constant-current passive-matrix array of claim 11, wherein the first constant-current source provides a first current and/or has a first size that is no more than 220% larger than a second current provided by the second constant-current source during operation and/or than a second size of the second constant-current source.

14. The constant-current passive-matrix array of claim 1, wherein the constant-current column-data signal comprises a pulse-width modulation signal.

15. The constant-current passive-matrix array of claim 14, wherein the constant-current column-data signal comprises a power signal representing different amounts of power or current.

16. The constant-current passive-matrix array of claim 15, wherein the power signal is a digital binary power signal having one, two, three, four, five, or six bits.

17. The constant-current passive-matrix array of claim 1, wherein the constant-current sources comprise two, four, eight, sixteen, thirty-two, or sixty-four constant-current sources.

18. A constant-current passive-matrix display, comprising multiple constant-current passive-matrix arrays according to claim 1,
wherein each of the constant-current passive-matrix arrays is a cluster and each of the clusters is disposed in a two-dimensional array comprising display rows and display columns,
wherein, for each of the display rows, all of the clusters in the display row are connected in common to a display row wire,
wherein, for each of the display columns, all of the clusters in the display column are connected in common to a display column wire, and
wherein the display comprises a display row controller connected to the display row wire of each of the display rows that is operable to select the display row wire for one of the display rows with a cluster row-select signal and a display column controller connected to the display column wire of each of the display columns that is operable to provide pixel values to each of the columns of clusters.

19. The constant-current passive-matrix array of claim 18, comprising a substrate on which the clusters are disposed and wherein the row controller and column controller are disposed between pixels on the substrate.

20. A constant-current column driver, comprising:
a column-control circuit operable to input a pixel value and output current-source enable signals; and
constant-current sources, each of the constant-current sources operable to output a fixed current in response to an enabling constant-current-source selection signal, wherein outputs of the constant-current sources are electrically connected in parallel to provide a constant-current column-data signal.

21-33. (canceled)
